(19) United States
(12) Patent Application Publication
(10) Pub. No.: US 2013/0332221 A1
(43) Pub. Date: Dec. 12, 2013

(54) Method And System For Determining Critical Information Interfaces

(71) Applicant: Siemens Aktiengesellschaft, Munchen (DE)

(72) Inventors: Alexander Fay, Hamburg (DE); Alexander Gellermann, Vastorf (DE); Tobias Jaeger, Erlangen (DE)

(21) Appl. No.: 13/915,837

(22) Filed: Jun. 12, 2013

(30) Foreign Application Priority Data
Jun. 12, 2012 (DE) 102012209798.8

(51) Int. Cl. G06Q 10/06

(52) U.S. Cl. CPC G06Q 10/06313
USPC 705/7.23

(57) ABSTRACT

A method and device are disclosed for determining critical information interfaces between fields of activity of an electronically documented process, the method including: (a) providing a binary dependency matrix between the fields of activity of the process; (b) rating the information interfaces between the fields of activity of the process that are specified in the binary dependency matrix based on predefined criteria that are read out from a criteria database in terms of their respective expression in relation to the read-out criteria in order to generate a numeric dependency matrix; and (c) evaluating the generated numeric dependency matrix in order to determine information interfaces of the process that are critical in respect of at least one target function.

### CROSS-REFERENCE TO RELATED APPLICATIONS

This application claims priority to DE Patent Application No. 10 2012 209 798.8 filed Jun. 12, 2012. The contents of which is incorporated herein by reference in its entirety.

### TECHNICAL FIELD

This disclosure relates to a method and a system for determining critical information interfaces between fields of activity of an electronically documented process.

### BACKGROUND

In many processes it is necessary to determine critical information interfaces between different fields of activity of the process. For example, it is necessary in the case of planning processes in the plant engineering and construction field to identify or determine critical information interfaces between different fields of activity in order in particular to take account of the ever-shortening lifecycles of installations. Efficient management of projects is often the deciding factor in the awarding of a contract to build an installation. Accordingly, plant engineering and construction enterprises in particular are faced with the challenge of coordinating all project activities in manifold interdisciplinary activities in the planning and execution of the construction of the installation with one another in such a way that a largely trouble-free project delivery is ensured. The most disparate technical disciplines encompassing different fields of activity are involved in the implementation of an installation project, said disciplines realizing the planning, construction and commissioning of a technical installation or manufacturing process in a reciprocal interaction across different phases of the project execution. A network of relationships is created as a result of the concatenation of different fields of activity. With the traditional approach, ignorance of these mutual dependencies therefore leads to unwanted iterations which conflict with efficient project delivery in terms of the planning, construction or commissioning of the installation.

### SUMMARY

One embodiment provides a method for determining critical information interfaces between fields of activity of an electronically documented process, comprising the steps of: (a) providing a binary dependency matrix between the fields of activity of the process; (b) rating the information interfaces between the fields of activity of the process that are specified in the binary dependency matrix based on predefined criteria that are read out from a criteria database in terms of their respective expression in relation to the read-out criteria in order to generate a numeric dependency matrix; and (c) evaluating the generated numeric dependency matrix in order to determine information interfaces of the process that are critical in respect of at least one target function.

In a further embodiment, at least one document in each case is transferred in electronic form via the information interface of the process as the working result from a generating field of activity of the process into a separate field of activity of the process making use of the working result.

In a further embodiment, each field of activity of the process comprises a plurality of working steps for generating the respective working result.

In a further embodiment, the readable criteria database stores criteria relating to the availability of information, criteria relating to the reliability of information, and criteria relating to the generation of information.

In a further embodiment, prior to the rating the information interfaces of the process are prefiltered based on statistical evaluations of the documents transferred in electronic form between the fields of activity of the process.

In a further embodiment, the criteria read out from the criteria database are weighted relative to one another.

In a further embodiment, the numeric dependency matrix is evaluated by means of selectable threshold values for classifying the information interfaces as critical or noncritical.

In a further embodiment, at least one critical information path of the process is calculated from the determined critical information interfaces of the process.

In a further embodiment, the calculated critical information path of the process is output for the purpose of determining technical measures which reduce the criticality of the information interfaces contained in the critical information path.

Another embodiment provides a computing system for determining critical information interfaces between fields of activity of an electronically documented process, comprising: a document management system which provides a binary dependency matrix between the fields of activity of the selected process; a rating computing unit which rates information interfaces between the fields of activity of the selected process that are specified in the provided binary dependency matrix based on predefined criteria that are read out from a criteria database in terms of their respective expression in relation to the read-out criteria for the purpose of generating a numeric dependency matrix which is evaluated in order to determine information interfaces of the selected process that are critical in respect of at least one target function.

In a further embodiment, one or more electronic documents or files in each case can be transferred via the information interfaces of the process as the working result from a generating field of activity of the process into a separate field of activity of the process making use of the working result.

In a further embodiment, each field of activity comprises one or more working steps which can be carried out manually or automatically by units for the purpose of generating at least one working result.

In a further embodiment, the determined critical information interfaces of the process are influenced in their information flow, in particular under open- or closed-loop control, by a control unit of the computing system in order to reduce their criticality in respect of at least one target function.

Another embodiment provides a planning system for a planning process for planning a project which automatically determines critical information interfaces of the planning process by performing any of the methods disclosed above.

Another embodiment provides a system for a manufacturing process for manufacturing products which automatically determines critical information interfaces of the manufacturing process by performing any of the methods disclosed above.

### BRIEF DESCRIPTION OF THE DRAWINGS

Example embodiments are explained in more detail hereinbelow with reference to the attached figures, in which:

FIG. 1 is a flowchart intended to illustrate an exemplary embodiment of a method for determining critical information interfaces;

FIG. 2 is a block diagram intended to illustrate an exemplary embodiment of a computing system for determining critical information interfaces;

FIG. 3 is a diagram intended to explain the mode of operation of the disclosed method for determining critical information interfaces;

FIG. 4 is a diagram intended to illustrate a hierarchical classification system of a workflow intended to explain the mode of operation of a method for determining critical information interfaces;

FIG. 5 shows a table intended to explain a possible differentiation of criteria, as can be employed in the disclosed method;

FIG. 6 is a diagram intended to illustrate an exemplary process in which the disclosed method for determining critical information interfaces can be used;

FIG. 7 shows a binary dependency matrix for the example illustrated in FIG. 6 intended to explain the mode of operation of a method for determining critical information interfaces;

FIG. 8 shows an exemplary rating table which can be used in the disclosed method for determining critical information interfaces;

FIG. 9 shows a further possible exemplary rating table, as can be employed in the disclosed method;

FIG. 10 is a diagram intended to explain the classification of an information interface, as can be performed in the disclosed method;

FIG. 11 shows a table intended to illustrate an exemplary rating of criteria in the disclosed method, as can be performed in the example illustrated in FIG. 6;

FIG. 12, 13, 14, 15 show tables for the various interfaces for the example illustrated in FIG. 6;

FIG. 16 shows the transfer from a binary dependency matrix BAM into a numeric dependency matrix NAM; and

FIG. 17 shows matrix representations of individual criteria.

### DETAILED DESCRIPTION

Embodiments of the present disclosure provide a method and a system for determining critical information interfaces between fields of activity of an electronically documented process which permit efficient project delivery, in particular in the plant engineering and construction sector.

For example, some embodiments provide a method for determining critical information interfaces between fields of activity of an electronically documented process, comprising the steps of:
(a) providing a binary dependency matrix between the fields of activity of the process;
(b) rating the information interfaces between the fields of activity of the process that are specified in the binary dependency matrix based on specified criteria that are read out of a criteria database in terms of their respective expression in relation to the read-out criteria in order to generate a numeric dependency matrix; and
(c) evaluating the generated numeric dependency matrix in order to determine critical information interfaces of the process in respect of at least one target function.

In a possible embodiment of the method at least one document or one file is transferred in electronic form via the information interface of the process in each case as the working result from a generating field of activity of the process to a separate field of activity of the process making use of the working result.

In a possible embodiment of the method each field of activity of the process comprises a plurality of working steps for generating the respective working result.

In a possible embodiment of the method the readable criteria database stores criteria relating to the availability of information, criteria relating to the reliability of information, and criteria relating to the generation of information.

In a possible embodiment of the method the information interfaces of the process are prefiltered prior to the rating based on statistical evaluations of the documents transferred in electronic form between the fields of activity of the process.

In a further possible embodiment of the method the criteria read out from the criteria database are weighted relative to one another.

In a further possible embodiment of the method the numeric dependency matrix is evaluated by means of selectable threshold values for classifying the information interfaces as critical or noncritical.

In a further possible embodiment of the method at least one critical information path of the process for determining technical measures which reduce the criticality of the information interfaces contained in the critical information path is output from the determined critical information interfaces of the process.

Other embodiments provide a computing system for determining critical information interfaces between fields of activity of an electronically documented process, comprising

a document management system which provides a binary dependency matrix between the fields of activity of the selected process;
a rating computing unit which rates information interfaces between the fields of activity of the selected process that are specified in the provided binary dependency matrix based on predefined criteria that are read out from a criteria database in terms of their respective expression in relation to the readout criteria in order to generate a numeric dependency matrix which is evaluated for the purpose of determining information interfaces of the selected process that are critical in respect of at least one target function.

In a possible embodiment of the computing system one or more electronic documents or files in each case can be transferred via the information interfaces of the process as the working result from a generating field of activity of the process to a separate field of activity of the process making use of the working result.

In a further possible embodiment of the computing system each field of activity comprises one or more working steps which can be carried out manually or automatically by units for the purpose of generating at least one working result.

In a possible embodiment of the computing system the determined critical information interfaces of the process are influenced in their information flow by a control unit of the computing system for the purpose of reducing their criticality in respect of at least one target function.

Other embodiments provide a planning system for a planning process for planning a project, which planning system automatically determines critical information interfaces of the planning process by being configured:

to provide a binary dependency matrix between the fields of activity of the planning process,
to rate information interfaces between the fields of activity of the process that are specified in the binary dependency matrix based on predefined criteria which are read out from a criteria database in terms of their respective expression in relation to the read-out criteria in order to generate a numeric dependency matrix, and
to evaluate the generated numeric dependency matrix for the purpose of determining information interfaces of the process that are critical in respect of at least one target function.

Other embodiments provide a manufacturing process for manufacturing products having the features disclosed herein.

Other embodiments provide a system for a manufacturing process for manufacturing products, which system determines critical information interfaces of the manufacturing processes by being configured:

to provide a binary dependency matrix between the fields of activity of the process,
to rate information interfaces between the fields of activity of the process which are specified in the binary dependency matrix based on predefined criteria which are read out from a criteria database in terms of their respective expression in relation to the read-out criteria for the purpose of generating a numeric dependency matrix, and
to evaluate the generated numeric dependency matrix for the purpose of determining information interfaces of the process that are critical in respect of at least one target function.

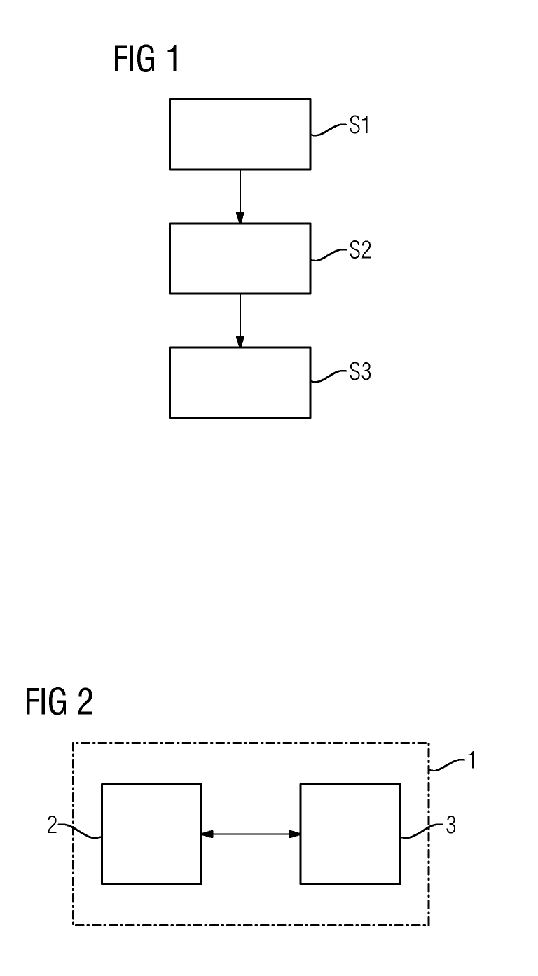

As can be recognized from FIG. 1, the disclosed method for determining critical information interfaces between fields of activity T of an electronically documented process P comprises several steps in the illustrated exemplary embodiment.

In a first step S1 a binary dependency matrix BAM is provided between the fields of activity T of the process P. The process P is an electronically documented process, wherein at least one document or one file in each case is transferred in electronic form via information interfaces IS of the process P as the working result AE from one generating field of activity gT of the process P to another separate field of activity vT of the process P making use of the working result AE. One or more working steps for generating the respective working result AE are performed in a field of activity T of the process P. The process P can be for example a planning process for planning a project. Furthermore the process P can also be a manufacturing process for manufacturing products. In the first step S1 at least one binary dependency matrix BAM is provided between the fields of activity T of the process P; this can also be referred to as a binary design structure matrix DSM. Various forms of causal or temporal dependencies of fields of activity T of the respective process P can be represented with the aid of the binary dependency matrix BAM. Individual activities T are set opposite one another in the activity-related design structure matrix DSM or binary dependency matrix BAM and a dependency between two activities T is indicated by means of a symbol or flag.

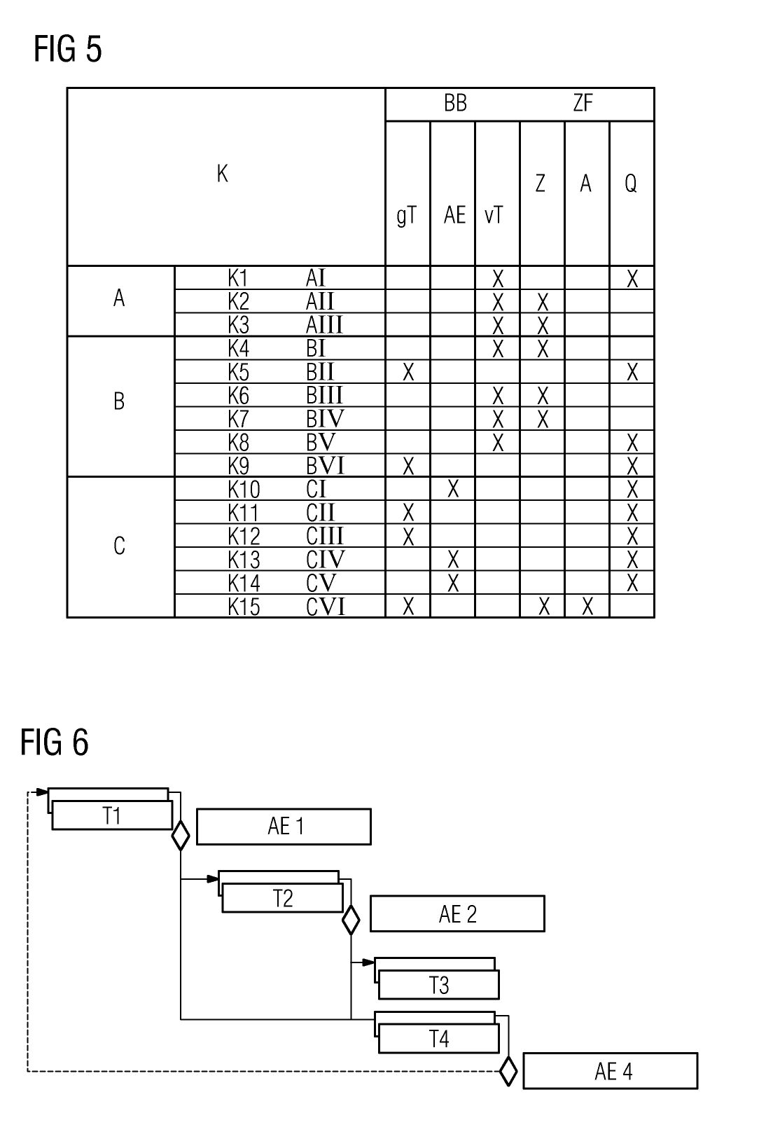

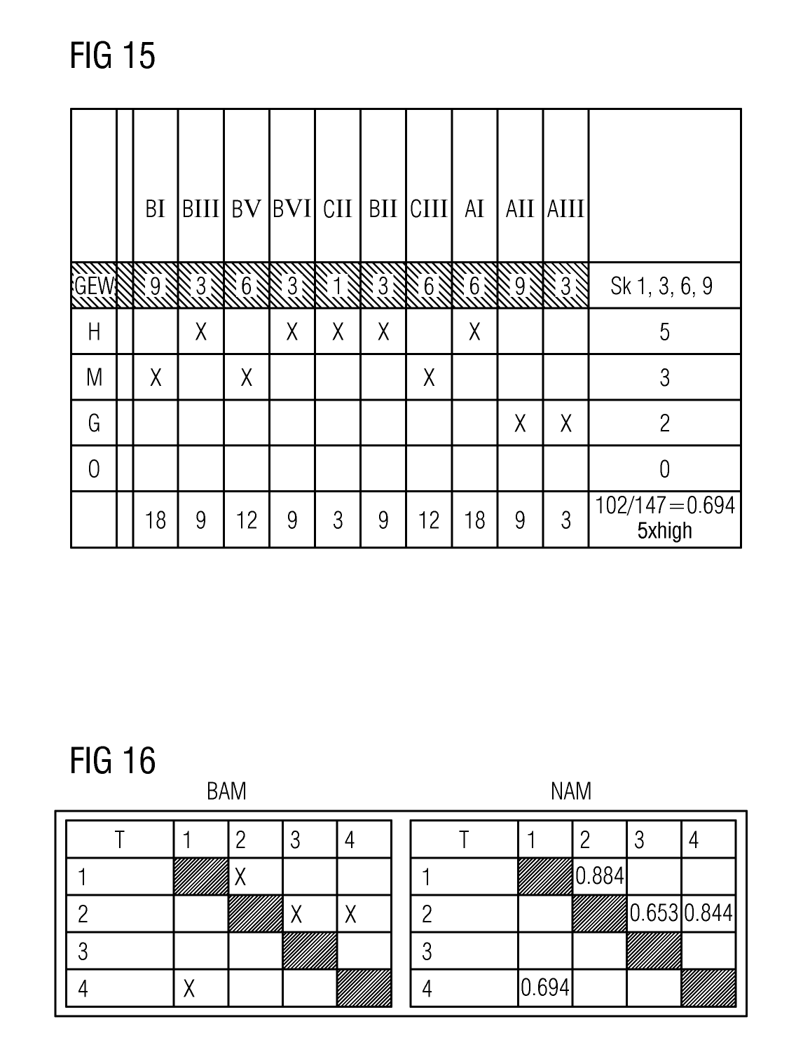

In a further step S2 of the method illustrated in FIG. 1 information interfaces IS between the fields of activity T of the process P that are specified in the at least one binary dependency matrix BAM are rated based on predefined criteria K. The criteria K are read out from a criteria database KDB. The information interfaces IS are rated based on the predefined criteria K in terms of their respective expression in relation to read-out criteria for generating a numeric dependency matrix NAM. FIG. 16 shows for example the information of a binary dependency matrix BAM and a numeric dependency matrix NAM for the example illustrated in FIG. 6.

In a further step S3 there follows the evaluation of the generated numeric dependency matrix NAM for determining information interfaces IS of the respective process P that are critical in respect of at least one target function ZF.

Different variants of the method illustrated in FIG. 1 for determining critical information interfaces IS in fields of activity T of an electronically documented process P are possible.

In a possible embodiment variant the information interfaces IS of the process P are prefiltered prior to the rating in step S2 based on statistical evaluations of the documents or files transferred in electronic form between the fields of activity T of the process P.

Next, in step S2, the information interfaces IS between the fields of activity T of the process P that are specified in the binary dependency matrix BAM are then rated based on predefined criteria K that are read out from a criteria database KDB.

In a possible embodiment variant the criteria K read out from the criteria database KDB are criteria relating to the availability of information, criteria relating to the reliability of information, and criteria relating to the generation of information. This differentiation into criteria groups A, B, C is shown by way of example in the table according to FIG. 5. In the example illustrated in FIG. 5 fifteen different criteria K are differentiated. One group A of criteria K includes criteria relating to the availability of information. A second group B of criteria K includes criteria relating to the reliability of information. A third group C includes criteria K relating to the generation of information. The table shown in FIG. 5 specifies a relevance of a criterion K in terms of a field of observation BB and different target functions ZF. The field of observation BB can include the generating activity gT, the working result AE or the following activity vT which makes use of the working result AE. The time Z, an overhead A and a quality Q are specified in the table as possible target functions ZF.

In a possible embodiment variant the criteria K, as shown by way of example in the table, which are read out from the criteria database KDB can be weighted relative to one another.

For example, in a possible embodiment variant the numeric dependency matrix NAM can be evaluated by means of selectable threshold values SW for classifying the information interfaces IS as critical or noncritical. In a further possible embodiment variant of the exemplary embodiment illustrated in FIG. 1 a critical information path of the process P is calculated from the determined critical information interfaces IS of the process P. The calculated critical information path of the process P can be used for determining technical measures which reduce the criticality of the information interfaces IS contained in the critical information path. Thus, for example, a process planner can establish where critical information interfaces IS in terms of one or more target functions ZF exist within the process P and where a critical information path will possibly stand in the way of a successful realization of the project.

FIG. 2 shows a simple block diagram intended to illustrate an exemplary embodiment of the computing system 1 for determining critical information interfaces IS in the fields of activity T of an electronically documented process P.

In the exemplary embodiment shown the system 1 has a document management system 2 which provides a binary dependency matrix BAM between the fields of activity T of the selected process P. In addition the system 1 includes a rating computing unit 3 which rates information interfaces IS between the fields of activity T of the selected process P which are specified in the provided binary dependency matrix BAM based on predefined criteria K that are read out from a criteria database KDB in terms of their respective expression in relation to the read-out criteria K for generating a numeric dependency matrix NAM.

This numeric dependency matrix NAM is subsequently evaluated in order to determine information interfaces IS of the selected process P that are critical in respect of at least one target function ZF. One or more electronic documents or files can be transferred in each case via said information interfaces IS of the process P as the working result AE from a generating field of activity gT of the respective process P to a separate field of activity vT of the process P making use of the working result AE. The field of activity T comprises one or more working steps which can be carried out manually or automatically by units for the purpose of generating at least one working result AE.

In a possible embodiment variant of the system 1 illustrated in FIG. 2 the determined critical information interfaces IS of the process P are influenced in their information flow by a control unit of the computing system for the purpose of reducing their criticality in respect of at least one target function ZF. This influencing can consist for example in the open- and/or closed-loop control of the information flow.

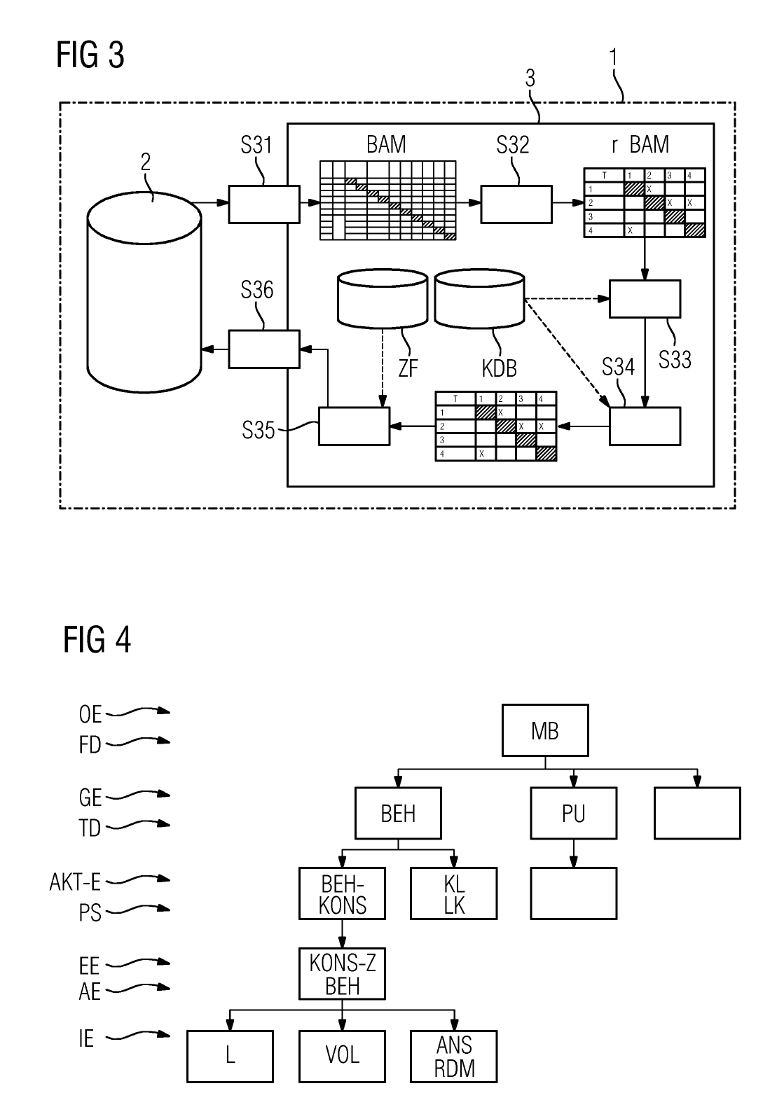

FIG. 3 shows a diagram intended to explain the mode of operation of a possible exemplary embodiment of a disclosed method for determining critical information interfaces in fields of activity T of an electronically documented process P. It can be seen in FIG. 3 that a document management system 2 is connected to a rating computing unit 3. Firstly, in a first step S31, initial system modeling can be carried out in a plurality of dependency matrices with an electronically documented workflow of the process P.

One or more binary dependency matrices BAM are generated in the first step S31, as shown in FIG. 3.

In a further step S32 relevant information interfaces IS between fields of activity T of the electronically documented process P are optionally focused on or prefiltered. A reduced binary dependency matrix rBAM can therefore be generated, as shown in FIG. 3.

In a further step S33 a qualitative examination for rating individual information interfaces IS according to specific criteria K can be carried out with the aid of the criteria K read out from a criteria database KDB.

In a further step S34 a refined system modeling of numeric dependency matrices NAM can be performed based on the quantified criteria expressions. This results in one or more numeric dependency matrices NAM for the respective process P that is to be examined.

Furthermore, in a step S35, the numeric dependency matrices NAM can be evaluated in order to identify critical information interfaces IS or information flows or work sequences and if necessary an optimization can be performed in addition with the aid of target functions ZF.

In a further step S36 the determined results are transferred in modified electronic documented workflows back to the document management system 2 by the rating computing unit 3, as shown in FIG. 3.

In a possible embodiment variant steps S31 to S36 can be performed automatically. Starting from existing or known interfaces or information interfaces IS, the method illustrated in FIG. 3 enables an at least partially automated assessment of effects of different individual factors on the delivery of a project as a whole. In this case the criteria database KDB serves for rating the information interfaces IS in a documented engineering process. The criteria database KDB is embedded in a workflow conforming to the method for the systematic rating of at least one, typically many, information interfaces IS of the process P. By means of the disclosed method it is possible, in addition to the pure acquisition of relationships, also to perform a classification in respect of critical and noncritical information interfaces IS. Over and above this, an automated analysis can be performed across a plurality of criteria, information flows or work sequences to reach an overall assessment of a set of information interfaces in respect of defined factors or target functions ZF. These target functions ZF include for example a time-related risk, a technical risk or an overhead risk for the project.

An information interface IS relates to a generating activity gT, the working result AE thereof, and a following dependent activity vT which makes use of a working result AE of the generating activity gT. The information interface IS accordingly represents an information dependence between two organizationally separate fields of activity T, an exchange of information taking place in electronic form between the fields of activity T. In the interface consideration the primary focus is not only on the working result AE of a specific activity T in this case, but also on the information or data that is part of the working result AE and is considered relevant by the following working steps. It may be that all the information of a working result AE is relevant. In this case the information interface IS relates to the overall working result. Furthermore organizational units can be responsible for the project activities.

In addition to the pure technical specifics the information can also include project organization information. The information interfaces IS occur for example in an engineering workflow of the plant construction or of other types of project and are characteristic in a collaborative workflow involving various participants.

The criteria database KDB serves for the systematic analysis of the information interfaces IS defined at the preparatory stage. The function of the criteria database KDB is the content-related separation of different characteristics of an information interface IS.

The starting point for the use of the database of the catalog is the existing objectively correct documentation of the entire engineering workflow. Preferably the documentation of the engineering workflow is available electronically, for example by means of workflow description languages or in workflow/project/document management systems. This can be realized e.g. in the form of Gantt charts, flowcharts, IDEF/ARIS diagrams or critical paths in such a way that activities together with the respective working results AE, the responsible organizational sectors and the information requirements necessary in each case are visible on a document basis. If this form of documentation does not exist, then it is first created. The processes P can by all means be represented also in a different form. It must, however, be possible to derive the interfaces IS, within the meaning of the definition, from this type of documentation. It may be necessary to map the levels arising in FIG. 4 from the documentation, namely an organization level OE (e.g. mechanical engineering MB) as specialist discipline FD, a group level GE comprising subdisciplines TD (e.g. containers BEH and pumps PU), an activity level AKT-E comprising process steps PS (e.g. container design BEH-KONS, characteristic curves KL and performance curves LK), a result level EE comprising documented working results AE (e.g. engineering drawing KONS-Z of the container BEH), as well as an information level IE (e.g. linear dimension L, volume VOL and connection ANS tube diameter RDM.

The criteria database KDB is structured as follows: Shown first are the categories together with the associated criteria K. Contained in this overview are a brief description in relation to each criterion K and a further assignment to the target functions ZF. Next, the criteria are listed individually. Each criterion K is described individually and can also be illustrated by means of an example case. The description of the criterion K is always given in standardized form according to a fixed scheme. Here, the category or group of the criterion K is defined first. There then follows the name of the criterion. The criterion K can be characterized by means of a short description. This is followed by the specification of the reference level in which the hierarchy level to which the criterion K relates is defined.

For the purposes of the subsequent rating, possible expressions of the criterion K can be specified in its description. The possible expressions of the criteria K constitute what are called variables which can be determined by means of qualitative investigations. These variables are preferably ordinally scaled. In other words, the variables possess expressions in a specific order. This is generated in the criteria database KDB by means of the possible expressions G “low”, M “medium” and H “high”. According to the criteria database KDB the expression “high” H has the strongest criticality. “Medium” M and “low” G form gradations in the criticality sequence. Thus, the expressions of the criteria can be set up in a specific direction by means of the variables. The criteria database KDB can be supplemented with the expression “no rating” O. This expression is used if no statement can be made in relation to a specific criterion K. The criterion K is then dropped from the rating system and has no distorting effects on the examination or rating.

The possible expressions are preferably coded numerically. In other words, hidden behind each expression is a number which is integrated as a weight into a computing method. The following table shows the possible expressions with the associated numeric values.

| Expression | Assigned numeric value |
|---|---|
| High H | 3 |
| Medium M | 2 |
| Low G | 1 |
| No rating O | 0 |

Quantitative values can be defined for the criteria K in order to differentiate between the individual expressions. Classification into the respective expression takes place based on these quantitative values. Not all criteria K are defined in this case by means of quantitative values for the different expressions. Some of the criteria can be characterized by “soft” factors. These factors must be defined by experts in advance ahead of the analysis as a function of the project that is to be examined. The approach to the classification of the criteria K and the subsequent rating system remain unaffected by this, however.

In the interests of organizational clarity the criteria K can be grouped into certain categories. For the purposes of the categorization they are firstly assembled into a content-related category and secondly differentiated according to their target function ZF. In this case the target functions ZF can be derived from the magic triangle of project management. This means that the effects of the criteria K are reflected in time, cost or quality/scope problems, the quality/scope problems addressing challenges in terms of the technical implementation of the installation. These target functions ZF are categorically not to be considered in isolation from one another, since almost all effects are to be transformed into the other effects in each case. Thus, for example, the time requirement can also be transformed into costs and the technical effects into time-related effects. The target function ZF named in the criteria K accordingly relates only to the direct effects of the respective criterion K.

The individual criteria K focus on different areas of the interfaces IS. The categorization represented in the listing subsumes these different areas of the interface. As described hereinabove, the working process which produces a working result AE necessary for the information exchange necessarily belongs in the consideration of the interface analysis just as much as the following activity. As categories, FIG. 5 shows to which areas of the interface IS the individual criteria relate.

The content-related categories A, B, C of the criteria K are for example:
availability of the information,
reliability of the information,
generation of the information.

The individual criteria K are presented in more detail hereinbelow. The criteria K are differentiated therein by means of the content-related categorization. The numbers preceding the criteria correspond to the numbers in the criteria database KDB.

In their semantic form/structure, in the classification and assignment to fields of observation and target functions ZF, as well as in the form of the quantification of qualitative information, the criteria K themselves represent an aspect of the method. The naming of the individual criteria K and of the different expressions of the individual criteria varies depending on the field of observation (project delivery or development workflow).

The first step S31 of the method is the modeling of the documented engineering workflow and the relationship network activities T resulting therefrom in a binary design structure matrix or binary dependency matrix (BAM). Different forms of causal and temporal dependencies can be represented with the aid of a BAM. In the activity-related DSM it essentially applies that individual activities are listed opposite one another and the dependency between two activities T is represented by setting a symbol or flag and stored. Thus, for example, the matrix form can be inferred from electronic system modeling by means of Gantt charts.

FIG. 6 shows by way of example a process P comprising different activities T and their working results AE.

In the interests of simplicity, modeling in a flowchart can also be carried out as an intermediate step in advance. This lends itself as an option in particular when the structure of the Gantt charts is very complex and the dependencies extend across a plurality of sets of individual workflow documentation.

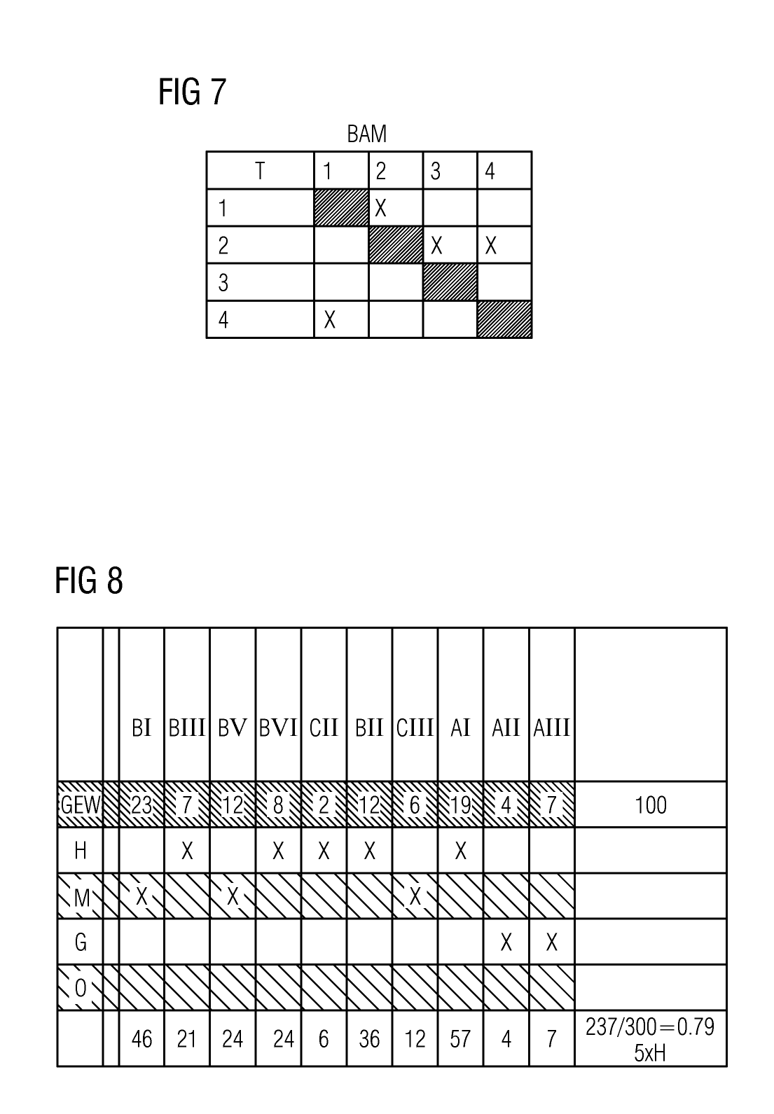

FIG. 7 shows a binary dependency matrix BAM for the example according to FIG. 6.

In FIG. 7 the represented working result AE4 is to be seen as a check result. A check of the requirements facing an engineering task is to be made with the aid of the working result AE4 in such a way that the working step sequence one to four is to be repeated in the event of deviations from specifications. The feedback indicated in FIG. 7 constitutes an extension of the Gantt chart which in that form can find application only in small subsections of projects, since the time bar is not taken into consideration as a superordinate orientation instrument. If this form of documentation is possible, modeling in matrices should be performed. FIG. 7 reveals the associated binary dependency matrix BAM.

Four interfaces IS in total are documented in binary form in FIG. 7 between the activities T one and two, two and three, two and four, and between four and one. The interface IS 41 from four to one is to be understood as an iteration which only occurs when deviations from specifications make it necessary to repeat or iteratively improve the results of the activities one, two and four. The interfaces IS must be able to be relocated in the matrix representation.

The focusing on relevant information interfaces in step S32 is a relevant step in the analysis of complex projects. Depending on the documentation of individual working steps or work packages, the number of interfaces IS after the definition of the work can assume a magnitude which no longer allows every interface IS to be considered in the workflow. As many as 1500 interfaces IS can be exceeded in some plant engineering and construction projects. This often makes it necessary to perform a method step S32 in order to contain the interface analysis IS.

In principle such a containment can be accomplished in several ways. A first possible containment is effected by focusing the interface analysis on known problem areas in the project, where this relates e.g. to installation components, specific project tasks or even specific project phases. Another focus can be realized e.g. through the limitation to interfaces IS along the time-critical path. This time-critical path is clarified e.g. by means of a network diagram. Delays to activities T along this path lead directly to an extension of the project runtime.

Within the scope of the analysis, limiting the number of interfaces IS can also be regarded as a preanalysis. Proceeding based on the results of the preanalysis it is necessary to decide whether further investigations will be productive in terms of the more efficient organization of the project delivery or whether a further examination of all other interfaces IS promises an advantageous cost-benefit ratio.

One possibility for generally performing a containment is the statistical evaluation of the documented workflows. The workflows are preferably examined under the following aspects:
How many documents or files are generated by an organizational sector?
How many documents are required by an organizational sector?
What status must the respective documents have (input/output)?
How many documents are necessary for generating an individual document?

Since these questions cover only some of the criteria K of the criteria database KDB and the catalog specifically discloses the different characteristics of interfaces IS, the containment based on the statistical evaluation does not have to reveal all the problem areas in terms of efficient project delivery. However, if no other reference points for containment are present, a static evaluation should be resorted to. Organizational sectors which generate a multiplicity of documents frequently also have a high degree of dependency on other sectors. Organizational sectors requiring a multiplicity of documents should also be assessed.

The status of documents can provide a pointer to the project phases, since a low status is often an indicator of early project activities. A dependency structure can be set up referred to each individual activity T. The higher the number of documents requiring to be exchanged, the more critical the interface IS should be considered. The containment then takes place based on the evaluated dependency structure. It is, however, necessary to point out that activities T that possibly require only a small number of input documents can prove to be critical as the project progresses.

In small projects, as in the example case in FIG. 6, it is still possible to perform the evaluation manually. However, since there are more than 100 interfaces IS to be considered in most cases, a statistical evaluation cannot be carried out manually. The evaluation is therefore performed in an automated manner. The evaluation can be supported with the aid of pivot tables. Pivot tables offer the possibility of evaluating large volumes of data in simple table form. This entails reading out and aggregating data and visualizing it in tabular form. For the purposes of evaluation using pivot tables it is necessary to transform the raw data into a form suitable for evaluation. This can be realized e.g. in Microsoft Office EXCEL. In this case the input documents, activities T, output documents and organizational sectors responsible must be stored in EXCEL sheets in such a way that they can be read out with the aid of the pivot tools in EXCEL. The activities T having the most input documents and the activities T having the most subsequent process steps can be identified based on this evaluation. Focusing on the areas of these activities appears beneficial, but should also be backed up in some other form.

This backup can take the form of expert discussions. Project management experts possess a general overview of a project and are therefore acquainted with specific problem areas or are able to derive from empirical values areas in which problems of any type may arise. Polling the opinions of experts in order to contain the interface analysis is to be preferred because this is most likely to throw light on the interfaces IS relevant to practice in order to minimize risk. The statistical evaluation serves herein to support these expert discussions and can consolidate the conclusions reached by the experts or also draw attention to possible problem areas which in turn should be confirmed by experts.

The focusing enables a containment of interfaces IS to be achieved which allows a further content-related consideration of the interfaces IS. More detailed consideration of the interfaces IS takes place in the next step.

A qualitative examination and interface rating are carried out in step S33. The activities described in the following can be carried out prior to the overall examination during the specification of the examination objectives, but can also be performed explicitly only in this step. An advantage of performing the activities in this step is that the rating can be adapted to the interfaces being focused on.

In preparation for the deeper penetration into the interfaces it is first necessary to determine the criteria K which are to be effective during the examination. These can be for example all fifteen criteria K of a catalog stored in the criteria database KDB or a selection of said fifteen criteria K that is specifically geared to the target functions ZF. If necessary, project-specific criteria K that are additionally to be introduced must likewise be determined if the examination is to be extended to that effect. An examination manager can specify the criteria to be examined according to the corresponding target function ZF. If the specification is not made by the examination manager, the examination manager must make a choice of criteria K in accordance with the objectives set for the analysis.

After all the criteria K have been determined and entered in the rating table, the criteria K can be weighted relative to one another by the examination manager. This is necessary because not all criteria K have the same significance with regard to the objectives of the analysis. If this weighting is not applied the examination can nonetheless be performed, even if the results of the examination will then not be so significant. The weighting of the criteria K is undertaken once in an examination and is fixed for the remainder of said examination. In order to compare two interfaces IS the weighting as basis must always be the same. A change in the weighting can, however, be made in a phase-by-phase consideration of the interfaces IS. In that event, though, only the interfaces IS within a phase can be compared with one another.

Basically, different scalings of the weighting are used in embodiment variants. The decision as to which of the scalings is chosen for the examination rests with the examination manager. It is possible on the one hand to start from a certain number of points (e.g. 100) and distribute these over all the criteria K to be examined. Expressed in different terms, this means that the sum of the weightings assumes a numeric value determined in advance. Another possibility results from the determination of scaled numeric values which accordingly reflect the significance of the criterion K. For the rating system, the numeric values 1, 3, 6 and 9 have been determined for the weighting. The number 1 stands in this case for the lowest significance, the number 9 for the highest significance. The numbers 3 and 6 form gradations of the two extreme values. Since the weightings of the criteria K must always be set in relation to one another, no linguistic formulations are attached to the scale values. Other finely scaled numeric values are possible, but this can make the practical implementation more difficult.

The specification of bounds for the classification of critical interfaces IS can likewise be undertaken by the manager.

Prior to the actual analysis a qualitative examination for preparing the interface rating can take place in a step performed by the person carrying out the examination. Starting from the constraining statistical results, the individual interfaces IS are considered in more detail in this case.

Firstly, the interfaces IS are examined in terms of the exchanged documents or files. The more documentation there is, the more accurate the results of this examination can be. Relevant examination variables are the document names, document status and the timelines represented in the Gantt charts. First derivations relating to the information to be exchanged and its criticality can be arrived at based on these three variables. In the case of e.g. a P&ID diagram, the document name can give an indication that the information concerns the process control system positions. The document status and the time required for the activities T that generate the information to be exchanged provide further reference points.

Other available information concerning the workflow can also be evaluated in this step. Possibly there are fault reports or process FMEA data present which allow a more detailed consideration of the interfaces IS.

The above-cited possibilities for the first qualitative evaluation of the interface IS that is to be considered serve primarily for building a database to support further examinations by a competent person. An estimation of the criteria of the criteria database KDB can be carried out for each interface IS individually with the aid of experts. Since all the information to be evaluated has been examined at a preliminary stage, experts can rate the expression of each criterion K.

The rating can be modeled on the quality function deployment (QFD) approach, where customer requirements are transferred into technical scopes of supply and services in that quantified customer requirements and performance parameters are reconciled with one another.

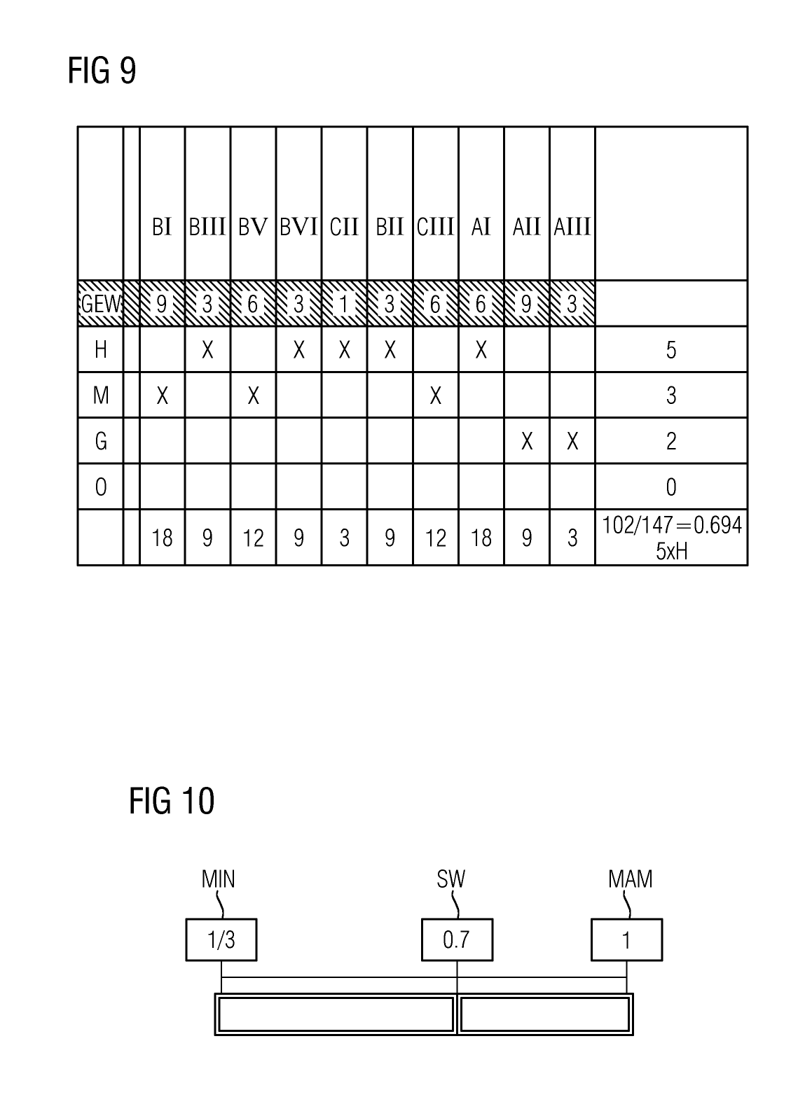

The rating system is explained with the aid of a rating table. The rating table is structured as follows. The criteria K specified for the examination of the interface are entered in a header line of the rating table. A selection of ten criteria K has been made in FIGS. 8 and 9. These are given in the first line of the rating table. The scalings of the weightings are listed in the second line in both figures.

The expressions of the individual criteria K presented in the criteria database KDB are listed in the first column, the numeric coding in the second column. The coding is accomplished through the assignment of numeric values to the expressions. In this scheme the expression “high” H is assigned the numeric value three, the expression “medium” M the value two, and the expression “low” G the value one. The expression “no rating” O is provided with a value of zero. This ensures that the expression without a rating will have no result-influencing effect.

The framework of the stored rating table is established by the determination of the criteria K to be examined, their weighting relative to one another, and the coding of the possible expressions. The actual examination of the interface IS can now take place.

The cross in any column clarifies the following computing operation. The product is determined from the weighting of the respective criterion K and the associated expression. The product is listed in the bottom line. The sum is formed from all of the individual products listed in the bottom line. This is noted in the cell at bottom right. The sum constitutes the quantified rating of the interface IS. In order to obtain a conclusion from the sum, it must be placed in relation to the highest possible number of points. This number of points is yielded as a result of the multiplication of the weighting of the criteria by the value three, since the latter corresponds to the expression “high”. The weighting of the criteria K remains unaffected thereby.

At its maximum the ratio can assume the value one. The maximum is reached by classifying all expressions in the criteria as high. If certain criteria cannot be rated, the potential maximum number of points cannot be reached. In order to preserve the ratio nonetheless, the unrated criteria must be calculated out of the possible maximum number of points (maximum number of points minus weighting times three). This factor must be taken into account for the comparison of the interfaces with one another. The same basis is used for the comparison in all cases. This means that the unratable criterion is excluded for all interfaces IS or is given a subsequent rating.

Assuming all the criteria K can be rated, the smallest sum to be reached is the summation of the weightings of the individual criteria. In total, a minimum of a third can result in this way in the ratio of the number of points reached to the highest possible number of points. The span possible between the maximum MAX and the minimum MIN for the rating accordingly lies at around a third to one and therefore has size of two thirds. A differentiation of the individual interfaces IS across this range is possible.

The interfaces IS are classified based on the ratio. The object of the classification is to group the interfaces into critical and noncritical. For this purpose a bound SW must be defined for the ratio. In other words, above a bound SW the interface IS is classified as critical. A possible bound SW can be e.g. the value 0.7. FIG. 10 shows the classification into critical and noncritical interfaces IS with the value 0.7 as bound SW.

An additional classification is applied through the evaluation of the numbers of the respective expressions. The background to this additional rating method is that with borderline decisions (value of the ratio lies just under the 0.7 bound) it must be examined whether an interface IS is nonetheless to be rated as critical based on other factors. It is entirely possible that seven of ten criteria K in the expression have been classified as “high” H, yet the bound of 0.7 has not been exceeded due to the possibly lower significance of these criteria K. In this case an additional bound for the maximum number of “high” expressions may be useful. If the evaluation exceeds this bound, the interface IS is automatically to be classified as critical. It should be noted, however, that the weighting of the individual criteria has no influence with regard to this bound.

The two bounds for the ratio and for the number of expressions must be specified by the examination manager in advance of the examination. These bounds can be changed according to the sensitivity of the examination. The specification of the bounds represents an important element of the rating system in this case, since the actual classification is based on this foundation. In the specification of the bounds the main focus of attention should be on the bound for the ratio. In contrast to the number of “high” expressions, the individual weightings of the criteria also have a bearing in the ratio. The number of “high” expressions is preferably used as an additional classification instrument.

In the result of the rating all the interfaces IS have been rated on a uniform basis in terms of the criteria K to be examined and have been classified into critical and noncritical interfaces by means of two bounds. The basis is accordingly laid for numeric system modeling in dependency matrices. The steps in the rating sequence are illustrated once again with the aid of the process flow shown in FIG. 6.

For the process flow shown in FIG. 6, an examination is to be performed for all four interfaces. This means that, separately from the other interfaces, an interface IS is to be classified in relation to each criterion K and subsequently rated in accordance with the rating system.

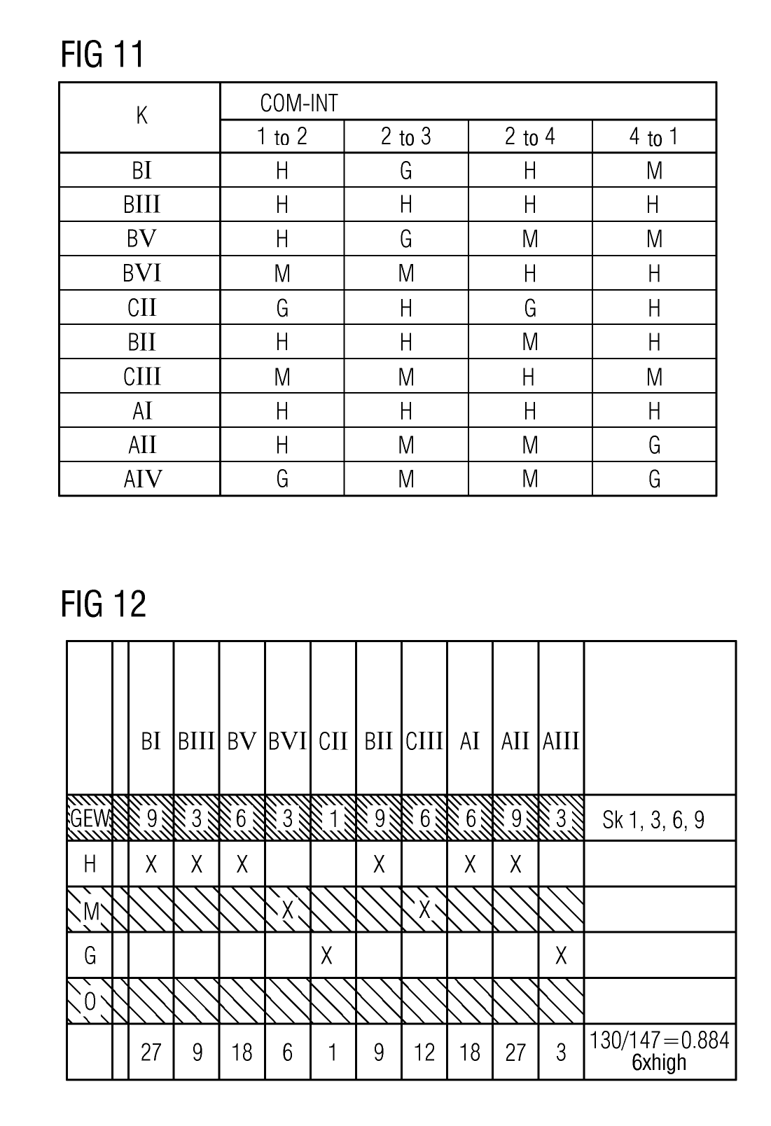

For the purposes of the rating, the ten criteria K—change overhead, information depth, dependency level (forward and backward), coordination overhead, change probability, communication overhead, content-related information requirements, information time, and information priority—have been chosen or selected by the examination manager. The weighting of the criteria K was agreed in a management group and the scaling specified using the numeric values 1, 3, 6 and 9. The bound for the ratio value was fixed at 0.7. The maximum permissible number of high expressions has been limited to four by the examination management. FIG. 11 shows a table with an example rating of criteria K.

The expressions of the individual criteria K are classified per interface IS by the person conducting the examination based on expert discussions and the consolidation based on the examination of fault reports as well as of the maturity levels of the individual working results. For the example process, the interfaces ID are rated by way of example. The rating table can be filled out in accordance with the classifications of the table as shown in FIG. 11. In this case four rating tables are maintained separately from one another. The rating tables of the individual interfaces IS are revealed in the following.

The ratio values from the rating tables are shown in the cell at bottom right. With a ratio of 0.884, the interface IS12 has the highest value, while the interface IS23 has the lowest, with 0.653. The interfaces IS12 and IS24 are to be classified directly as critical because they exceed the bound of the maximum permissible ratio value of 0.7. The interface IS23 does not exceed this bound and is therefore to be classified as noncritical. At 0.694, the ratio of the interface IS41 is actually below the bound, but since the number of high expressions H, at five, lies above the limit of four, the interface IS41 is nonetheless to be regarded as critical.

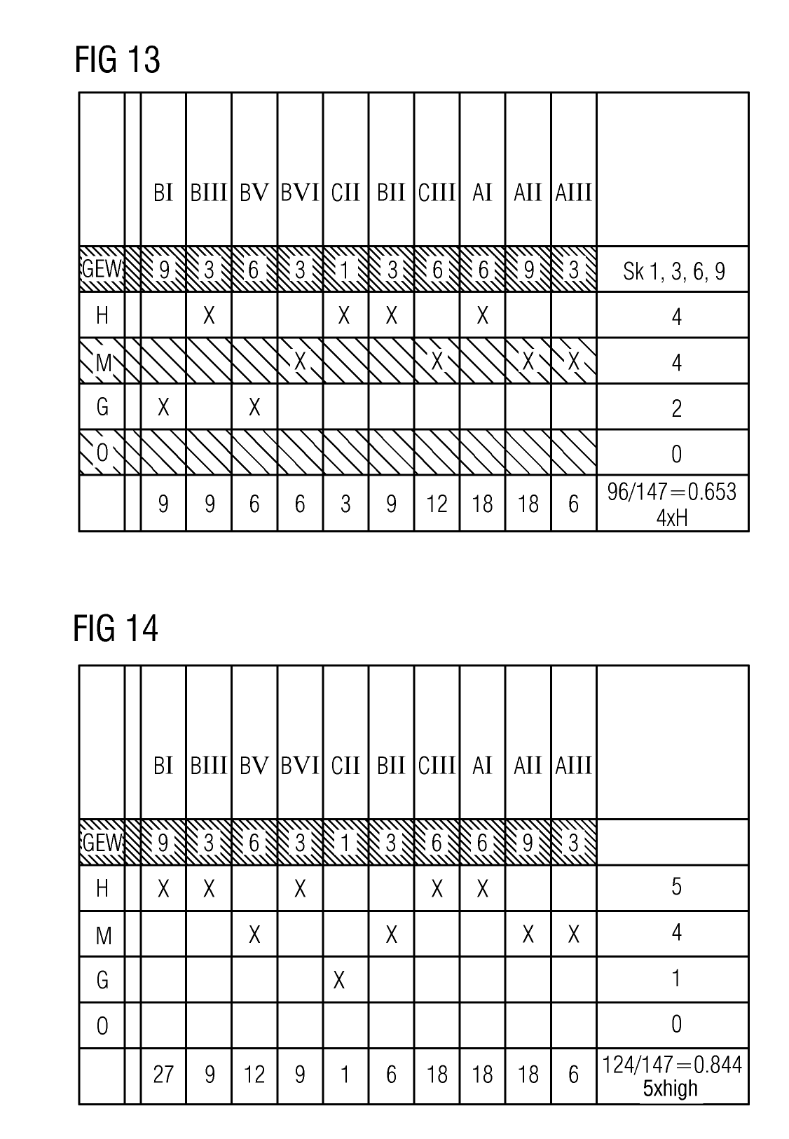

FIG. 12 shows the rating table of the interface IS12.

FIG. 13 shows the rating table of the interface IS23.

FIG. 14 shows the rating table of the interface IS24.

FIG. 15 shows the rating table of the interface IS41.

As a result of the individual rating of the interfaces IS numeric system modeling can take place in step S34 on this basis. In this case the interfaces IS to be considered remain the same as in the case of the binary system modeling. FIG. 16 shows the transition from the binary BAM to the numeric NAM.

FIG. 16 takes up the exemplary process flow and the ratio values of the example rating here. It can be seen that, instead of the binary relationship network, the interface IS can now be represented numerically. For this purpose the values of the interface rating are transferred to the placeholders of the binary BAM.

The dependency matrix shown here is a one-dimensional dependency matrix, because it only considers the accumulated ratio values. For the purpose of the further evaluation the matrix does not, however, have to consider accumulated values exclusively. It is possible to take all the individually rated criteria K into account per interface IS. A matrix can therefore be given multiple dimensions. Each dimension stands for a criterion K of the interface rating. In the case of the criteria drawn upon in the example rating this would result in a ten-dimensional matrix. Since this matrix is not to be visualized in that form, all the dimensions are to be revealed in individual dependency matrices. However, the weighting of the criteria K must be taken into account. This means that the products from the coded expression of the criterion K and the scaled numeric value of the weighting are entered in the individual matrices. The weighting is to be specified as well in the labeling of the respective matrix in order to enable the product and the matrix as such to be evaluated better and demarcated with respect to each other. Thus, the actual expression can be recognized indirectly via the weighting. FIG. 16 shows the matrices for the first four criteria of the interface rating from the example rating.

This definitive form of listing the results of the interface rating is of advantage in particular when no containment of the criteria to be examined is carried out prior to the analysis. Once all the criteria K of the catalog have been considered and rated, a target orientation can be performed subsequently.

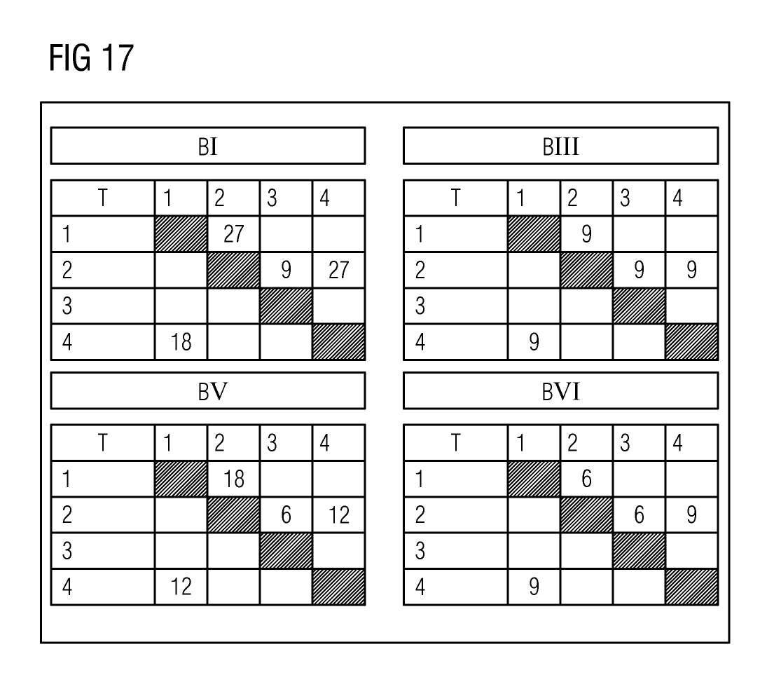

As the result of the numeric system modeling a numeric DSM (NAM) can be generated which reflects the interfaces IS by means of accumulated ratio values. Matrices associated with all criteria K for the examined interfaces can likewise be generated in this step of the methodical approach, as shown in FIG. 17.

The penultimate step S35 of the method illustrated in FIG. 3 is the evaluation of the numeric DSM (NAM). The numeric NAM with the accumulated ratio values enables critical individual interfaces to be identified and represented by means of algorithmic evaluation. Thus, for example, the interface IS12 from the exemplary process profile can be identified as a critical individual interface. The evaluation of the matrix does not, however, cease with the identification of critical individual interfaces. If all interfaces of a DSM are considered, critical information paths can also be discovered. Iteration steps in the engineering workflow can be clarified by way of the matrix representation. Such an iteration step can be made out via the interfaces IS12, IS24 and IS41 already by way of the binary DSM (BAM). The advantage of the numeric representation is that on this basis the iteration cycle as a whole can be assessed in terms of criticality. In the case of the example rating, all the interfaces IS belonging to the iteration cycle are to be classified as critical. In this case the entire iteration is to be rated as critical. This results in a critical information path.

The critical information path does not have to relate only to iterations in the engineering workflow. The path can also be produced as a result of the sequential concatenation of a plurality of critical interfaces in the workflow. These critical paths are particularly relevant in the course of the efficient design of engineering workflows because they constitute an increased risk potential for successful project delivery.

Up to this point the interface analysis serves only for classifying critical interfaces. This classification ends with the identification of critical individual interfaces and information paths. Countermeasures need to be taken based on the identified critical individual interfaces and paths. The multi-dimensional matrix for representing the expression of each criterion forms the basis for developing countermeasures.

These countermeasures include primarily only the critical interfaces IS. The interfaces IS classified as noncritical from the rating are not taken into account any further in this step, since the main object in this step is to reduce the criticality of the respective interface IS. The interfaces classified as noncritical can nonetheless also be considered in terms of the efficient organization of the project delivery. In particular with the objective of a temporal optimization in mind, suitable measures can be initiated automatically based on the expert assessments in respect of the criteria database, e.g. measures such as the adjustment of the time that working results will be available to the requirements of the following work sections.

The possibilities that present themselves for the adoption or automatic initiation of countermeasures to reduce the interface criticality are drawn by way of example from the criteria formalization level and change probability. Concrete specifications in respect of interface optimization can be derived based on these criteria K. However, this exemplary consideration of the possibilities can only take place in a general manner in this work, since measures to reduce the criticality must be determined first and foremost from a practical application case.

Should the high expression of the formalization level criterion have led to a classification of the interface IS as critical, closer consideration of the information exchange may be beneficial. The relevant information exchanged should be clarified through expert discussions. These expert discussions can take place immediately after the classification in a second expert interview round or, given suitable capacity, incorporated directly in the first discussion round alongside the pure interface rating. In terms of the formalization level it is important to clarify whether and to what extent the information to be exchanged needs to be formalized. What needs to be weighed up is in what relation the time/labor overhead required in advance of the information exchange in respect of the formalization of the working results stands to the advantages of risk minimization. However, formalizing working results AE is fundamentally to be recommended in order to avoid room for interpretation in the evaluation and prevention of information gaps. Possible forms of formalization can be discussed based on the expert discussions. However, producing a format template for the information exchange is the responsibility of the organizational sectors affected by the interface IS.

The change overhead criterion should be evaluated in a similar way. If a high change probability leads to the classification as critical, means and ways must be found to make the interfaces IS stable in the face of the probable changes. This primarily concerns the activities T affected by the change. As far as possible the activities T should be adapted in such a way that changes have no great effects in terms of the extra effort required for their incorporation.

General engineering activities that are not necessarily dependent on the information having the high change probability can for example be brought forward in these working steps. Although this possibility does not reduce the change probability as such, the negative effects in terms of time in relation to the project delivery could be counteracted in this way. Another approach is to reduce change probability as such.

Measures to stabilize the relevant information are taken in particular when the effect of changes results in a high level of additional overhead. In this case it may be beneficial for example to adjust the necessary status of the information or the required working result AE.

Hierarchical merging can take place based on the expression of the activities-relationships structure. In other words, conclusions as a result of the expression of the activities T can be drawn at the subsection and section level. For example, it can thus be determined which section/group is exposed to especially high technical risks in the course of the project (because e.g. that is where many critical information threads converge) or for which section/group there is an especially high risk of a delay in the overall project schedule.

The criteria K stored in the criteria database KDB can include three groups A, B, C of criteria.

### [Group A] Availability of the Information

### [A1] Content-Related Information Content

Criterion: Content-related information content
Target function: Technical effects
Description: Information is required for a working step
Reference level: Information level and results level based on documented dependencies
Possible expression: If the information is not required, no interface exists!
   Low—the information is derived from other working results
   Medium—the information can be self-generated
   High—without the information the working step cannot lead to a result
Acquisition method: Qualitative acquisition only
Corroboration/source: Experts

The criterion “content-related information requirement” is fundamentally to be understood as a key criterion in the overall criteria database. This concerns whether a mandatory dependency relationship actually exists between two performance areas or not. If none of the information regarded as relevant is incorporated into a specific working step, then there is also no dependency relationship. In this case there is no reason to consider the interface any further, since according to the definition of an information interface IS it does not exist. The criterion is not provided with any expression. The facts of the case should be documented and communicated to project management.

If, on the other hand, information from a specific document is required, a classification according to the possible expressions should be completed. The classification “low” is then to be applied if the required information also emanates from other working results. If the information has to be generated by the section that requires it itself, then the expression of this criterion is “medium”. In contrast, it is “high” if the information cannot be generated either from other results or autonomously. This means that without the information a specific working step cannot lead to a result. However, it is important at this juncture to point out the risk of duplication of effort. If required information ought to be generated autonomously by certain sections, this means that the results are in turn to be made available to other sections, without the latter having to repeat the same working steps in order to generate the same information. If the results are not made available to other sections, two significant effects result. On the one hand the duplication of effort means that resource efficiency is not guaranteed in terms of the project delivery and on the other hand two sets of information diverging from each other may be generated by the duplication of effort. This means that e.g. end results can vary as a result of the application of two standards-compliant but different computing methods. Fixing on one value is then essential. However, if the rejected value has already been used for other working steps, it is also necessary to record a change overhead in addition to the duplication of effort.

The informational dependency is illustrated with the aid of the criterion “content-related information requirement”. The effects when necessary information is available to a following section relate to the performance parameters of the installation and are therefore technical in nature. However, the faster availability of required information when generated autonomously can also produce a time advantage for the overall project.

The “content-related information requirement” can be examined on the one hand based on consideration of the documented workflows and on the other hand based on expert interviews. The two reference levels “information level” and “result level” are therefore addressed by means of the criterion.

Calculations for load scenarios of specific equipment are an example of the content-related information requirement. The type and manner of the calculations are clearly specified by standards and operating regulations. Following sections can also perform the calculations themselves if they have appropriate resources (time, personnel, specialist knowledge, possibly machine capacities) at their disposal. The necessary information, in this example case the load scenarios, could thereby be available at an earlier time, which serves the interests of efficient project delivery.

### [A II] Information Time (In Percentage of the Working Step)

Criterion: Information time (in percentage of the working step)
Target function: Time-related effects
Description: Information is required “sometime” for a working step
Reference level: Information level and result level (time-related dependency)
Possible expression:
   Low—the information is required only toward the end of the working step (>70%)
   Medium—the information is required by 70% of the working step
   High—the information must be available at the start of processing
Acquisition method: Qualitative acquisition only
Corroboration/source: Experts

The next criterion of this category is the information time. It is to be assumed that it is not necessary in the case of all the working steps for the requisite information to be available at the beginning of the working step so that said step can be commenced. It is altogether possible for certain information to become relevant only in the course of a working step. This situation is taken into account with the “information time” criterion. The later the information becomes relevant for a working step, the more noncritical the interface is to be rated in relation to the information time.

Gradations in percent, referred to the total processing time, are necessary for specifying when information becomes relevant to a working step. However, if certain information has to be available from the outset because otherwise an activity cannot begin, the expression in the case of this criterion is “high”. If, on the other hand, it is sufficient to provide the information “subsequently” up to after 70% of the total processing time of the working step, then the information should be classified as less critical. The expression of the criterion will then be “medium”. If it suffices to make the information available later still, then the expression will be “low”.

The possible time shift in the preceding activities can be recognized with the aid of the graphical illustration. Better allocation of resources during the project delivery is possible by precise adjustment of the scheduling of such activities to the time of need. Time-related advantages for the delivery can be generated in this way when a project is considered globally.

Time-optimized interleaving of the project activities can be achieved by means of the “information time” criterion, with the aid of which the estimated time for the project runtime can be substantially shortened. The criterion therefore relates to the time-related effects during project delivery.

The actual information time can only be determined by experts. However, the information about the time of need can also be included in the workflow documentation on the result level. The different time segments can also be recorded in Gantt charts. This is an example of how Gantt charts can be geared to the needs of the users. If the different times of need were investigated in the documentation, then an examination of the documentation is sufficient for the classification of the possible expressions. If on the other hand the information time is not considered in further detail in the documentation, a classification must be made based on expert discussions.

The criterion can be illustrated based on construction tasks for specific devices. Initially, general project-neutral activities are carried out in such project tasks.

The incorporation in or adaptation to project-specific parameters takes place subsequently. It follows from this that not all the information needs to be present at the start of a particular activity. If the information were to be available substantially earlier, it would therefore still not be used any earlier. Only the information waiting time would increase. This, however, is not in keeping with resource-efficient project delivery. This is all the more true when individual resources could be deployed elsewhere in the context of multiproject management. Moreover it contradicts the principle of process management which states that information must be available at the right time and in the right quality for the right consumer. In project management, too early a time is likewise to be considered as a wrong time, even if this case is more advantageous for the project progression than a forwarding of information at too late a time. However, this factor is not critical for the interface per se, but is of greater significance for the project delivery as a whole.

### [A III] Information Priority

Criterion: Information priority
Target function: Time-related effects
Description: Information for a working step is required in a specific order of priority
Reference level: Information level and result level (time-related dependency)
Possible expression:
   Low priority—information is only relevant after the presence of other information
   Medium priority—the information is not required first of all, but also not last of all
   High priority—information is included first of all in the processing step
Acquisition method: Qualitative acquisition only
Corroboration/source: Experts

As mentioned in the example of the previous criterion, all the required information is not always necessary immediately at the beginning of a working step. However, if it should not be possible to specify a definitive time as a function of the processing step, a time-related optimization can nonetheless take place based on an order of priority. The “information priority” criterion takes responsibility for this order. The earlier it is necessary for information to be available, the higher its priority becomes. Accordingly an interface is to be regarded as critical in terms of this criterion if the information requiring to be exchanged is assigned a high priority. The possible expression stands against the background of the order of priority. The priority is high if the information is required immediately and consequently is incorporated “first” into a processing step. The expression for the criterion is in this case also to be classified as “high”. The mean in the case of this criterion is a broad field. By “medium” is to be understood all the information that is not immediately incorporated first of all into a working step, but is also not incorporated last of all. All the information that has a subordinate priority is assigned the classification “low”. This refers to all information that is not incorporated until all the other required information is available.

Similarly to the previous criterion, the “information priority” criterion also serves for the time-related optimization of the overall project. To that extent this criterion also should be associated with the “time-related effects” target function.

As in the case of the information time specified as a percentage, this criterion also should only be determined based on expert estimation. In this case, however, as with the previous criterion, the documentation can be extended in Gantt charts in such a way that the order of priority can be derived therefrom. The criterion accordingly relates to the information level for examining the order.

Analogously to the example of the information time, general information, such as e.g. general process instructions for mechanical design configurations, should be prioritized more highly since this information has to be available at the beginning of construction activities. Specific parameters which are not incorporated until later in the construction are accorded a correspondingly lower priority.

### [Group B] Reliability of the Information

[B I] Change Overhead
Criterion: Change overhead
Target function: Time-related effects
Description: Changing required information leads to a certain overhead when it comes to incorporating the change
Reference level: Information level and result level based on status identification
Possible expression:
   Low—only local adjustments to specific parameters (up to 20%)
   Medium—part of the working step requires rework (20%-80%)
   High—the entire working step is to be repeated from the beginning (>80%)
Acquisition method: Qualitative acquisition only, expert survey, status determination
Corroboration/source: Classification by experts required

The change overhead criterion describes the effects of changing input information in terms of the working step that is dependent on this information. It goes without saying that changing information within a document leads to a certain additional overhead when it comes to incorporating said change. Various expressions must be differentiated as a function of the scale of said change. With minor changes, which necessitate only local adjustments to certain parameters, the effects are to be classified as “low”. Measured against the estimated processing time of the affected working step, the additional overhead must not exceed 20% in this case. However, if a significant part of the working step needs to be reworked, the effects should be classified as “medium”. In this case the extra work must not be higher than 80%. As of 80% repetition activity for the affected working step, the effect is dramatic and consequently should be classified as “high”. In other words, the working step should be repeated from the beginning.

The target function ZF of this criterion K is the time-related effect. Changes that lead to additional overhead in the project can directly increase the project runtime. This should be avoided in the interests of efficient project delivery. However, extra work also leads to higher human resource costs in the project, because project members are tied in longer to an activity in order to incorporate the change.

The change overhead should be acquired only qualitatively based on expert surveys, since only these are familiar with the exact processing of the information. The experts should be composed primarily of persons with responsibility for the working step that is affected by the change in the information. As a result of the requirement for expert classification the information level is clearly specified as a reference level. The additional overhead involved in incorporating the change can be estimated only based on the specific knowledge concerning the relevant information from a document. At the level of the working results the knowledge concerning a change in the document gives no indication of the effects in terms of the additional overhead.

The change to an erroneous weight specification is chosen as an example of the change overhead. Error in this context does not mean that this was necessarily wrong from the outset, but rather that a change to the weight specification was unavoidable due to a consolidation of other information. In the case of static construction project planning, changes to weight specifications always lead to an additional overhead in respect of their incorporation. The overhead is essentially dependent on the extent of the change. However, since this already represents a combination with another criterion, the question of the extent of the change shall not be considered at this point. It will be taken up again in the next chapter. If there is an increase in the weights, e.g. of certain containers, the static pressure on the baseplate on which the container stands increases. The structural engineer then has the option of choosing other construction materials for the casting of the baseplate or of adapting the plate to handle the new loads by means of steel struts. The overhead should be relatively low in the planning phase. However, if the change occurs only later during a project running alongside the construction in which the installation for certain constructional measures already starts in parallel with the planning phases of the individual sections, it can happen that the entire baseplate has to be scrapped and recast. In this case the overhead for the change is of course considerably higher.

### [B II] Change Probability

Criterion: Change probability
Target function: Technical effects
Description: Change to relevant information is subject to specific probability
Reference level: Information level and result level based on status identification
Possible expression:
   Low—the probability of the change is less than 0.2
   Medium—the probability of the change is less than 0.6
   High—the probability of the change is greater than 0.6
Acquisition method: Qualitative acquisition only, expert survey, status determination
Corroboration/source: Classification by experts required

The occurrence of the change to information is subject to a specific stochastic variable. The change probability criterion accommodates these stochastic influences. The higher the probability of a change, the earlier it must be assumed that the overhead in the project will be increased due to rework. Furthermore the change probability affords the following section the possibility of managing the incorporation of the information in a flexible manner. The expression of the change probability is “low” as soon as the probability for a change to information is less than 0.2. If it is less than 0.6, then the possible expression is to be classified as “medium”. If a change with a probability of greater than 0.6 should occur, then the expression of the criterion is “high”.

The change probability is a technical variable. It is therefore also assigned to this target function ZF. In contrast to other criteria of this assignment, the change probability is an effect that is created as a result of technical planning. Not all the information can be generated directly at the beginning in a form that will no longer change. This is why a change probability arises.

How probable it is that there will be a change in specific information can be discerned based on the maturity level of a document. If the status of the document containing this information is low, then a change is more probable in relation to the document with a higher status. Specifying the status for documents and working results can accordingly give a first point of reference for the change probability. However, the individual information contained in the document can also be subject to a specific yet different maturity level. But since this is not documented in most cases, expert classifications are required for this. The experts must then estimate the information considered relevant by the following section in terms of its maturity level. To that extent this criterion relates to the result and information level.

Reference may be made to the lifecycle of the engineering documentation for pumps for a process control installation as an example of different change probabilities.

In this example the change to the information relates not to making the information more precise, but to the substitution of previously specified parameters. The pump documentation is required by various other sections for their engineering activities. However, the maturity level of the document and consequently also the information contained therein varies from section to section. The following sections request the engineering documentation with a specific maturity level as a function of the time/labor overhead involved in incorporating the change. The following sections are in this case situated in the relationship of tension between the stability of the information and the time-related availability of the information, since information of a lower maturity level in the project tends to remain more stable than information with a high status. The engineering documentation for pumps is based on the rough information of the containers and their volumes as well as on the substances to be conveyed and their properties. Furthermore, the pump configuration is dependent on automation requirements, pipe connections, electrical connections, and the overall application environment. The engineering documentation is also required in turn by the automation engineering, electrical engineering and civil engineering sections. For this reason all rough information relating to the conveying function of the pump is collected initially for the engineering documentation. On this basis the engineering documentation is first produced in a provisional document. Since flow rates, container volumes and the application environment are not yet definitively fixed at this time, the change probability in respect of the information contained in this document is quite high. However, the information that is essential to the dimensioning of the pumps becomes consolidated in the course of the project. Specifically with regard to automation engineering, many requirements will not be specified until later times in the project. The document is changed based on new knowledge and assigned a higher status. The document will possibly also undergo acceptance by the customer. The change probability will then decrease as a result of the incorporation of many other sets of information.

### [B III] Information Depth

Criterion: Information depth
Target function: Time-related effects
Description: Information is required in a specific precision of detail for a work process
Reference level: Information level
Possible expression:
   Low—limit parameter must be specified
   Medium—specific/certain parameters must be specified exactly
   High—very detailed information is required
Acquisition method: Qualitative acquisition only
Corroboration/source: Document names, experts

The information depth criterion relates to the level of detail of the required information. It is assumed that information with a quite specific precision of detail must be available for a specific work process. In this case the precision of detail can have different expressions. It is possible that only limit parameters need to be specified for the work process. This should be easier in the course of the project progression than providing very detailed information. In this case the expression for the criterion K is to be classified as “low”.

Should certain parameters need to be specified exactly by the following working step, the expression is “medium”. If, on the other hand, all the information in a high level of detail is relevant for the following processing step, then the expression of the criterion is “high”.

The target function ZF of the information depth is the time-related effect, since a time-related optimization of the project workflow can be achieved through the adjustment of the required information to the availability of the information.

The necessary level of detail of the information should preferably be determined by expert surveys. Only experts of the sections dependent on the information can make pronouncements concerning the content-related precision of required specifications. In connection with expert surveys, however, the document name can also provide information about the degree of detailing. This aspect is emphasized more clearly by means of the below-cited example. The criterion relates to the information level, so even if initial indications about the information depth can be given by means of document names, an expert survey is indispensable for the estimation.

To provide a better illustration, reference may be made to the example of flow diagrams. The information depth in flow diagrams ranges from the rough overview, through the process control workflow, to the definitive listing of all the required process control engineering points. It is by all means possible that following sections request a piping and instrumentation diagram (P&ID), although they will only read the process control workflow as information from it. The adequate block flow diagram was possibly not requested by the following section. Basically, however, the block flow diagram would be sufficient in respect of the information of the process control workflow. The disadvantage in making the request for the P&ID diagram lies in the time delay. The P&ID diagram takes considerably more time to produce than the block flow diagram, which is available at a very early stage in the course of the project. Thus, if subsequent activities require only the process control workflow as input information, they could be started and completed substantially sooner. The aforementioned document name is by all means a starting point for the precise tracking of the requisite information depth. For this purpose the document names of the flowcharts in projects must be clearly distinguishable from one another. If only one document for flowcharts is maintained in the project with a different status at any given time, it will not be possible to make a content-related differentiation via the document name.

### [B IV] Information Precision

Criterion: Information precision
Target function: Time-related effects
Description: Information within a specific margin is required for a work process
Reference level: Information level
Possible expression:
   Low—the parameters can deviate by more than 60% from the final value
   Medium—the parameters can deviate by up to 60% from the final value
   High—the parameters can deviate by up to 20% from the final value
Acquisition method: Qualitative acquisition only
Corroboration/source: Document names, experts

The next criterion presented here is the information precision. The information precision should be differentiated from the information depth. In contrast to the level of detail in the information depth, the information precision concerns the accuracy of the information. Often what is required by the following section is not an exact parameter, but a margin within which the relevant parameter lies. Particularly in technical layouts, precise values are rarely required immediately for the commencement of the engineering activities. It is often sufficient here to specify the order of magnitude within a certain margin in which the actual value will lie at a later time. However, the information has to be made more precise for more accurate layouts. As in the case of the information depth, an engineering workflow can also be time-optimized based on the knowledge about the requisite deviation margin, since a possibly large deviation margin can be provided for a rough guidance value earlier than the precise values. The possible expression in the case of this criterion relates to the percentage deviation margin within which the information must be available. It is assumed that in the case of an information interface the information precision should be classified as critical as soon as the required parameters are allowed to deviate from the later final value only by less than 20%. In this case the expression of the criterion is to be classified as “high”. With the classification “medium”, the information must not exceed a deviation of max. 60%. If the information is to be specified with a deviation of more than 60%, then the information precision is not critical and should be classified as “low”.

Like the previous criterion, the “information precision” criterion should also be assigned to the time-related effects. With this criterion, the required information and the time-related availability are likewise combined, such that a time-related optimization can be established as a result.

As also in the case of the information depth, the question of the degree of precision that the information must have so that the following sections can commence their engineering activities can only be answered by means of expert surveys. Accordingly this criterion too relates to the information level.

The information precision can be very well replicated by a structural engineer based on the required information. A structural engineer must firstly have a rough overview of the bearing loads that are to be expected in order thereupon to calculate the static layouts. At the start of his/her work a rough specification of the expected loads is sufficient for the structural engineer. He/she can always adjust the static layouts to the actual layouts at later times by means of steel struts and other materials. With very high loads, however, he/she must factor in other technical solution options, such as e.g. buttresses, into his/her planned layout from the outset. For this, he/she provisionally requires a rough guidance value. At a later time, however, he/she will require information about the actual weight loads, e.g. in order to specify the steel connection (bolted, welded, with or without flange plate, etc.), since the layout according to the actual loads must be completed based on different installation overheads and different cost estimates for material.

### [B V) Dependency Level (Forward)

Criterion: Dependency level (forward)
Target function: Technical effects
Description: Subsequent working steps are dependent on this information
Reference level: Information level and result level based on documented dependencies
Possible expression:
   Low13 information has no relationship with other working steps
   Medium—the information has a dependency relationship with several other working steps
   High—the information has a dependency relationship with many other working steps
Acquisition method: Quantitative acquisition
Corroboration/source: Documented workflow

The dependency level constitutes the next criterion. This criterion takes account of the network structure of the manifold dependency relationships. The dependency level is separated in the catalog into two different sections. The “forward” dependency level presented here relates to the subsequent working steps that are dependent on a certain working result. This means that a specific number of working steps are dependent on specific information or a document. It is to be assumed that the significance of the information or also of the document containing the information increases, the higher is the number of working steps dependent thereon. No dependency relationships are present for the expression “low”. However, if a working result is in a dependency relationship with several other working steps, then the expression for this criterion is “medium”. In the case of the “high” expression many working steps must be dependent on a document. The classification in the case of the soft bounds “several” and “many” must be made as a function of the project or subproject that is to be analyzed. However, the commensurability must be preserved across all the interfaces to be analyzed on account of the better possibilities for comparison.

The forward-side dependency level relates to the technical effects during the engineering activities in the project, since it reveals the dependency structure and consequently also technical interconnectedness.

If the information dependency is considered, this criterion likewise relates to the information level and must only be analyzed based on a targeted estimation by experts. For the dependency level it is, however, sufficient to replicate the dependency relationships of the document in which the required information is present. For this purpose the documented workflow in respect of the dependency structure can be read out and analyzed. To that extent a quantitative acquisition can suffice for this criterion with regard to the examination and later classification of the expression. The result level accordingly constitutes the basis for the evaluation.

### [B VI] Dependency Level (Backward)

Criterion: Dependency level (backward)
Target function: Technical effects
Description: This information is dependent on other information
Reference level: Information level and result level based on documented dependencies
Possible expression:
   Low—information has no relationship with other information
   Medium—the information has a dependency relationship with several other sets of information
   High—the information has a dependency relationship with many other sets of information
Acquisition method: Quantitative acquisition
Corroboration/source: Documented workflow

As already mentioned in the case of the previous criterion, the dependency level is subdivided into the two sections “forward” and “backward”. The criterion of the “backward” dependency level presented at this juncture thus relates to the number of working steps and their results that are necessary in order to generate a specific working result. Accordingly it does not relate to the following fields of activity, but to the preceding activities. The possible expressions, the reference level and the acquisition method for recording the relationship structure for this criterion essentially follow those of the forward-side dependency level. In this case, too, the soft analysis factors “several and many dependencies” must be specified at a preliminary stage of the examination as a function of the project.

The target function of the criterion “dependency level backward” corresponds to that of the forward-side dependency level and is to be derived from that criterion.

### [Group C] Generation of the Information

### [C I] Assumption Quantity

Criterion: Assumption quantity
Target function: Technical effects
Description: Iteration steps in engineering activities make it necessary to assume starting values. The number of assumptions that a working result has is an indicator of criticality
Reference level: Information level
Possible expression:
   Low—information has no assumptions
   Medium—a part of the working result is based on assumptions
   High—the entire working result is based on assumptions
Acquisition method: Qualitative acquisition
Corroboration/source: Expert estimations

As already demonstrated, in addition to their interdisciplinary character, engineering activities are characterized by iteration steps in the installation planning. For certain iteration steps it is necessary to make assumptions in order to progress the plant engineering and construction project. Within the context of the criteria database KDB, the number of assumptions made per working result is an indicator of the criticality of an interface IS. A working result AE in which many assumptions were made is basically assigned to a lower maturity level. Accordingly the criterion is also closely linked to the maturity level criterion, though relates with the assumption quantity to a different aspect. A further aspect for the criticality in relation to assumptions made is the extent to which assumptions are based on other assumptions made at an earlier time. This aspect must be differentiated from the assumption quantity criterion. This aspect is not listed in that form in the criteria database KDB, but can be added if necessary.

The “assumption quantity” criterion should be assigned to the target function ZF “technical effects” because it relates to assumptions in the technical planning of the installation. It has an effect on the maturity level of information and documents and in the case of a plurality of assumptions increases the risk in the technical implementation of an installation project.

The expression for the criterion K is characterized by soft factors. No assumption may exist within the required working result for the expression “low”. Accordingly the information contained in the working result AE is also assumption-free. If a part of the working result is based on certain assumptions, then the classification “medium” should be chosen for this criterion. In contrast thereto, the classification “high” should be chosen if the entire working result is based on assumptions.

In order to be able to estimate whether and when assumptions were made, and how many, in order to generate a specific working result, it is necessary to conduct an expert survey. It is not possible to represent the number of assumptions in the workflow documentation. For this reason it is not to be assumed that a classification into the possible expressions can be carried out based on the actual documentation.

There are many examples of iterations and mutual dependencies in the plant engineering and construction field. One example is working out the building layout. In this case assumptions are made in the initial phase of the building planning activities in order to develop provisional designs that are necessary for the planning work of other sections. A subsequent adjustment to the needs of the sections then takes place at later times. For this the specialist building planners in turn require the precise data from all the other sections. Accordingly, the number of assumptions made is an indirect indicator of the stability of the information contained in a document.

### [C II] Coordination Overhead

Criterion: Coordination overhead (number of sections involved)
Target function: Technical effects
Description: Communication/coordination with a plurality of different subsections is necessary in order to generate this information
Reference level: Information level
Possible expression:
   Low—information is generated in one section only
   Medium—several sections are involved for the information generation
   High—many sections are involved for the information generation
Acquisition method: Qualitative acquisition
Corroboration/source: Expert estimations

The criteria mapped in this category deal with the generation of a working result AE. When results are worked out it becomes clear in what relationship the result stands to the upstream work process. Within the context of the criteria database it is to be assumed that a particularly high overhead for the generation of working results AE is an indicator of the significance and hence also of the criticality of an interface. Often it is not feasible to document the overhead invested in generating results in workflows via Gantt charts because many “small” coordination actions cannot be represented on account of the lack of clarity. The coordination overhead is a specific overhead in results generation. The necessary integration of different specialist sections is addressed by means of this criterion. The interdisciplinary character of the engineering activities referred to in chapter 2 relates not only to the global view in the project, but also to individual activities which sometimes have to be carried out jointly or through mutual agreement. This criterion K concerns the number of differently involved organizational sections. The possible expressions in the case of this criterion are characterized by soft factors. These factors are necessarily dependent on the project that is to be examined. The expression “low” indicates that information is generated as a working result AE in one organizational section only, i.e. within a department or subdiscipline at the group level. If more sections are involved, the expression is “medium”. The soft factor “several” has been used for this classification in the catalog. These soft factors must be determined by means of bounds as a function of the project. For the expression “high”, a plurality of different sections is to be involved in the generation of a specific working result. Just as in the case of the expression “medium”, the soft factor “many” must be specified in relation to the project that is to be examined.

The coordination overhead criterion relates to the technical implementation of an installation. Accordingly it should be assigned to the target function “technical effects”. The technical implementation can be optimized as a result of better coordination that is geared to the requirements of the project.

The soft factors can be specified only based on an expert estimation. For this purpose specific bounds should be fixed with project management experts in advance of the actual examination. By means of these bounds classifications as of when a specific expression should be chosen can then be completed systematically. The classification itself must likewise be carried out by experts. However, these can be made up from the individual specialist departments rather than from the management personnel. Depending on the form of the documentation, the involvement of other specialist sections should be identified through the analysis of the Gantt charts. Where a plurality of specialist sections are involved, it is not, however, possible to represent them in Gantt charts in most cases on account of the poor degree of clarity. A qualitative expert survey is therefore indispensable for identifying undocumented dependencies in certain processing steps. This criterion accordingly relates to the information level.

Since these coordination actions in projects are either not or only rarely documented, it is difficult to cite exemplary activities in the engineering domain. It is, however, conceivable that activities that are declared sensitive at a preparatory stage of the project manifest a high level of coordination overhead with regard to the project management. Milestones and regular meetings are frequently introduced in the case of such activities in order to carry out checks on intermediate results. Although the coordination does not serve to resolve the project tasks, it is nonetheless necessary as an overhead serving to achieve mutual agreement.

### [C III] Communication Overhead

Criterion: Communication overhead
Target function: Technical effects
Description: Communication with other sections is necessary in order to generate this information
Reference level: Information level
Possible expression:
   Low—“over the wall approach”
   Medium—regular consultation with other section
   High—permanent consultations with other section
Acquisition method: Qualitative acquisition
Corroboration/source: Expert estimations

The previous criterion K deals with the number of sections involved during the generation of a working result. The following criterion relates to the communication that is necessary between the sections during the result generation.

In this case the communication overhead can be rated as an accumulation of the interdisciplinary collaboration. This criterion is focused in particular on a possible exchange of experiences between the following section and the section supplying information. Since according to the sender-receiver model, disruptions, regardless of what type, could certainly impede the transfer of information, where there is a high level of communication overhead the interface IS should be considered as critical in respect of this criterion. The possible expressions are therefore premised on the presupposition that the classification “low” will be applied if no communication with other sections takes place. The phrase “over the wall approach” has become established to describe this model. In the plant engineering and construction field it means that a working result is passed on to the following organizational section without any consultations. In practice this can be e.g. a file which is imported into a database in order thus to be available to all sections participating in the project. However, if regular consultation with other sections is necessary, this criterion is classified as “medium”. Permanent consultations classify the interface as critical, since possible communication disruptions may be prejudicial to the generation of the working result. Consequently the expression in the case of this criterion is “high” for this.

The communication overhead is associated with previous criteria and therefore relates likewise to the technical effects. In the case of this criterion, too, the implementation of technical project tasks can be improved through an adapted means of communication.

Communication is difficult to investigate in projects because it can be realized over numerous paths. A practical example relating to an actual working step will therefore be omitted from the presentation of this criterion. An approach to the examination could be the email traffic occurring in the project. However, this does not cover all of the communication paths. Many agreements are reached as a result of telephone calls, meetings, etc. Documenting them is either not possible or possible only with high investment of effort. An evaluation of all communication paths and overheads therefore appears incapable of realization. In order nonetheless to arrive at a classification of the possible expressions, the communication overheads must be determined qualitatively for all communication paths by experts. To that extent this criterion relates to the information level.

### [C IV] Formalization Level

Criterion: Formalization level
Target function: Technical effects
Description: Information is exchanged by way of formalized descriptions
Reference level: Information level and result level
Possible expression:
   Low—information is exchanged by way of predefined templates
   Medium—information is exchanged by way of partially formalized descriptions
   High—information is exchanged by way of free, informal descriptions
Acquisition method: Qualitative acquisition
Corroboration/source: Expert estimations

The editing of working results AE is extremely important for fast, error-free evaluation of information. Templates serving as document models are often available for this purpose. The structured layout of documents likewise serves as an aid to better evaluation. A further formalization is achieved by means of standards which specify structures and methodologies e.g. for drawings and calculations. However, certain working results cannot be generated via such formalized descriptions. Free, non-formal descriptions can, however, lead to essential information being forgotten or to ambiguities occurring. Room for interpretation in informal descriptions is definitely to be considered as critical, because it represents a source of erroneous assumptions. The formalization level criterion rates an interface precisely according to this aspect. The expression should be classified as “low” if the information exchange is realized by way of predefined templates. If no templates are available, but the documents are nonetheless structured, the criterion should be classified as “medium”. If the exchange is effected by way of free, informal descriptions, the formalization level is low. In this case the information interface can be exposed to the risk of misinterpretations or incomplete descriptions. The expression of the criterion should accordingly be classified as “high”.

The formalization level criterion should be assigned to the target function “technical effects”, since the technical planning activities in the engineering domain can be significantly improved as a result of the formalization of specific results.

The extent to which the results of certain processing steps are formalized or can be formalized cannot be recognized at the level of the working results. Accordingly, the classification of the individual expressions should be determined qualitatively by means of an expert survey. The formalization level criterion relates to the structure of the result editing and therefore addresses the information level.

When documents are globally standardized in the project and in the course of the standardization the form of the document is specified for all sections, the formalization level is high. An example from practice is the motors and components list (MCL), which reflects the basic electromechanical structure of an installation and is augmented by a number of sections. The form of this list and therefore also the visualization of the contents are always the same within a project. Thus, designations and technical data relating to the component, component type, the location identifier, and the superordinate linkage must always be entered in the columns and rows provided for that purpose. Accordingly, information can be passed on in a similar manner to a checklist in a form which can be evaluated quickly without any latitude for interpretation.

### [C V] Individualization Level

Criterion: Individualization level
Target function: Technical effects
Description: Information can be individualized for specific recipients
Reference level: Information level
Possible expression:
   Low—individualization is possible for all recipients
   Medium—individualization is partially possible
   High—the information exchange is realized by means of standardized information
Acquisition method: Qualitative acquisition
Corroboration/source: Expert estimations

In the editing of the working results AE it is necessary to examine not only the formalization level, but also the possibility of adaptation as befits requirements. It is conceivable for working results to be individualized for specific recipients so that the latter can evaluate the necessary information better from the results. Precise knowledge concerning the information relevant to the following sections is necessary in order to adapt the working results. For this reason the information exchange in respect of results which are strongly geared to the individual resource requesters should be rated as noncritical. The evaluation of documents that have not been adapted can have negative time-related effects in the case of an anonymous exchange. With regard to the individualization level criterion, the possible expression in the case of standardized results which have not been edited in any way for the following sections should be rated as “high”. If an individualization is possible in parts of a working result, the expression “medium” should be chosen. This criterion is assigned the expression “low” if an individualization can be realized for all the following sections.

The individualization level, like the formalization level, should be assigned to the technical effects. With this criterion, too, the improvements that can be generated are technical in nature, since an improved information evaluation is possible as a result of the individualization level.

The possibility of adapting working results AE to specific resource requesters should be elicited on the part of the project members. The classification in respect of the expression of the criterion must likewise be determined based on a survey of specialists. Accordingly the criterion relates, like the formalization level, to the information level.

A document such as the MCL can be individualized for specific following sections in that e.g. different parts of the document are highlighted in color. In this way a plurality of MCL versions are produced which, although all containing the same information, have been adapted for the different sections. The evaluation time can be reduced considerably in the case of such individualized documents. Accordingly individualizing the documents can result in an improvement of the overall process.

### [C VI] Time/Labor Overhead

Criterion: Time/labor overhead
Target function: Technical effects/effects in costs
Description: Generating the information represents a specific time-related and human resource overhead referred to the planned overall project runtime
Reference level: Activity level with documented times and human resources
Possible expression:
   Low—the overhead for the work process is low
   Medium—the overhead for the work process is average
   High—the overhead for the work process is considerable
Acquisition method: Qualitative evaluation
Corroboration/source: Documented workflow

The final criterion specified by way of the criteria database KDB is the time/labor overhead for the entire generation of a working result that is to be exchanged. The time/labor overhead relates in this case to the time-related and human resources aspect. Measured against the project runtime and the total number of employees involved over the course of the project delivery, the overhead for a specific processing step can be determined. In this case, however, the time-related and human resource dimensions must always be taken into account, since the overhead represents the sum of both. Thus, for example, a low time-related overhead can be due to the fact that the human resource overhead for the processing is relatively high and consequently the entire overhead in total is also considerable. The factors for the classification into the different expressions are soft and are geared to the project that is to be examined. For the purposes of the estimation it is first necessary to specify the average overhead for general activities. This average directly represents the level “medium”. If the overhead is significantly lower than the average overhead, the expression for this criterion is “low”. It follows that the classification “high” should be chosen when the working step lies considerably above the average.

Two target functions are to be assigned to the time/labor overhead on account of its duality (time expended and human resource costs). These are “time-related effects” and effects in terms of project costs due to the investment of human resources.

Basically the overhead is represented in the workflow documentation. Gantt charts are particularly well-suited to representing time-related overheads. However, the human resource overheads must be incorporated in addition in order to read the estimation of the time/labor overhead directly from the workflow documentation. If the documentation contains all the information necessary for the analysis, there is no need to conduct an expert survey. This only becomes relevant if the requisite time-related and human resource capacities are not known at the preparatory stage. Because of the possibility of examination, based on the workflow documentation, the time/labor overhead criterion relates to the activity level.

The generation of the piping and instrumentation diagram and the block flow diagram can be referred to by way of example in order to illustrate the activities. Compared to the generation of the process control block flow diagram, generating the P&ID diagram is associated with a higher overhead because the information content is substantially higher in the P&ID diagram. In terms of the time/labor overhead criterion K the P&ID diagram as the working result should accordingly be assigned a higher expression than the block flow diagram.

What is claimed is:

1. A method for determining critical information interfaces between fields of activity of an electronically documented process, the method comprising:
providing a binary dependency matrix between the fields of activity of the process;
rating the information interfaces between the fields of activity of the process that are specified in the binary dependency matrix based on predefined criteria that are read out from a criteria database in terms of their respective expression in relation to the read-out criteria in order to generate a numeric dependency matrix; and
evaluating the generated numeric dependency matrix in order to determine information interfaces of the process that are critical in respect of at least one target function.

2. The method of claim 1, comprising transferring at least one document in electronic form via the information interface of the process as the working result from a generating field of activity of the process into a separate field of activity of the process making use of the working result.

3. The method of claim 1, wherein each field of activity of the process comprises a plurality of working steps for generating the respective working result.

4. The method of claim 1, wherein the readable criteria database stores criteria relating to the availability of information, criteria relating to the reliability of information, and criteria relating to the generation of information.

5. The method of claim 1, comprising, prior to the rating the information interfaces, prefiltering the process based on statistical evaluations of the documents transferred in electronic form between the fields of activity of the process.

6. The method of claim 1, comprising weighting the criteria read out from the criteria database relative to one another.

7. The method of claim 1, comprising evaluating the numeric dependency matrix using selectable threshold values for classifying the information interfaces as critical or noncritical.

8. The method of claim 1, comprising calculating at least one critical information path of the process from the determined critical information interfaces of the process.

9. The method of claim 8, comprising outputting the calculated critical information path of the process for determining technical measures that reduce a criticality of the information interfaces contained in the critical information path.

10. A computing system for determining critical information interfaces between fields of activity of an electronically documented process, the computer system comprising:
a document management system configured to provide a binary dependency matrix between the fields of activity of the selected process; and
a rating computing unit configured to rate information interfaces between the fields of activity of the selected process that are specified in the provided binary dependency matrix based on predefined criteria that are read out from a criteria database in terms of their respective expression in relation to the read-out criteria for generating a numeric dependency matrix that is evaluated to determine information interfaces of the selected process that are critical with respect to at least one target function.

11. The computing system of claim 10, wherein one or more electronic documents or files are transferrable via the information interfaces of the process as the working result from a generating field of activity of the process into a separate field of activity of the process making use of the working result.

12. The computing system of claim 11, wherein each field of activity comprises one or more working steps that are manually or automatically executable by units for generating at least one working result.

13. The computing system of claim 10, wherein the determined critical information interfaces of the process are influenced in their information flow via open- or closed-loop control by a control unit of the computing system in order to reduce their criticality in respect of at least one target function.

14. A planning system for a planning process for planning a project which automatically determines critical information interfaces of the planning process by performing a method comprising:
providing a binary dependency matrix between the fields of activity of the process;
rating the information interfaces between the fields of activity of the process that are specified in the binary dependency matrix based on predefined criteria that are read out from a criteria database in terms of their respective expression in relation to the read-out criteria in order to generate a numeric dependency matrix; and
evaluating the generated numeric dependency matrix in order to determine information interfaces of the process that are critical in respect of at least one target function.

15. The planning system of claim 14, configured to transfer at least one document in electronic form via the information interface of the process as the working result from a generating field of activity of the process into a separate field of activity of the process making use of the working result.

16. The planning system of claim 14, configured to, prior to the rating the information interfaces, prefilter the process based on statistical evaluations of the documents transferred in electronic form between the fields of activity of the process.

17. The planning system of claim 14, configured to weight the criteria read out from the criteria database relative to one another.

18. The planning system of claim 14, configured to evaluate the numeric dependency matrix using selectable threshold values for classifying the information interfaces as critical or noncritical.

19. The planning system of claim 14, configured to calculate at least one critical information path of the process from the determined critical information interfaces of the process.

20. The planning system of claim 19, configured to output the calculated critical information path of the process for determining technical measures that reduce a criticality of the information interfaces contained in the critical information path.
